(19) United States
(12) Patent Application Publication
(10) Pub. No.: US 2013/0165200 A1
(43) Pub. Date: Jun. 27, 2013

(54) GAMING DEVICE WITH PATTERN DISPLAY

(71) Applicants: L. Donald Speer, II, San Diego, CA (US); W. Greg Shay, San Diego, CA (US); Kevin McIntosh, San Diego, CA (US); Donne Grable, San Diego, CA (US)

(72) Inventors: L. Donald Speer, II, San Diego, CA (US); W. Greg Shay, San Diego, CA (US); Kevin McIntosh, San Diego, CA (US); Donne Grable, San Diego, CA (US)

(73) Assignee: VCAT, LLC, San Diego, CA (US)

(21) Appl. No.: 13/338,117

(22) Filed: Dec. 27, 2011

(51) Int. Cl. A63F 13/00

(52) U.S. Cl. 463/20

(57) ABSTRACT

Embodiments of the present invention are directed to gaming devices having a pattern display associated with game play on the gaming device, and methods of operating the gaming device to generate, modify, and interact with a pattern on the pattern display. In one instance, a method of operating a gaming device includes determining a pattern-modifying game outcome in response to a received player input, modifying a displayed pattern, and awarding a prize when the modified pattern satisfies a predetermined prize threshold.

### FIELD OF THE INVENTION

This disclosure relates generally to gaming devices, and more particularly to gaming devices having a pattern display associated with game play on the gaming device, and methods of operating the gaming device to generate, modify, and interact with a pattern on the pattern display.

### BACKGROUND

With games of chance, gaming players are often looking for enjoyable entertainment as well as a chance of winning a large prize. If players are not enjoying a game, they will often seek another type of game, or another activity altogether, to spend money on. Game manufactures and casinos try to balance the need to keep games familiar and relatively uncomplicated while trying to provide new and entertaining games that players will enjoy.

Typically, game results of gaming devices are determined by analyzing a series of random selections associated with the game. For example, in spinning reel slot machines, a reel-stop position for each reel is randomly selected. Once each random selection is made, the combination of randomly selected reel-stop positions is analyzed to determine if the combination of symbols associated with the reel-stop positions results in an award for the player. Similarly, in video poker or blackjack random cards are selected and then analyzed to see if the combination of randomly selected cards results in an award for the player. However, these familiar game processes often make many games seem similar to one another. That is, even though a game theme or button layout of a game may be changed, it often feels similar to other games. One thing that players often seek is more personal choices during game play. Player choice or familiarity of an aspect of game play can keep the player more entertained, as they have a say in their gaming experience.

### BRIEF DESCRIPTION OF THE DRAWINGS

FIG. 1 is a functional block diagram that illustrates a gaming device according to embodiments of the invention.

FIG. 2 is an isometric view of the gaming device illustrated in FIG. 1.

FIG. 3 is a functional block diagram of networked gaming devices according to embodiments of the invention.

FIG. 4 is a detail diagram of a gaming device having a pattern display according to embodiments of the invention.

FIG. 5 is a detail diagram of another gaming device having a pattern display according to embodiments of the invention.

FIG. 6 is a detail diagram of another gaming device having a pattern display according to embodiments of the invention.

FIGS. 7A, 7B, 7C, 7D, and 7E are detail diagrams showing an example progression of game play on a pattern display of a gaming device according to embodiments of the invention.

FIGS. 8A, 8B, 8C, 8D, and 8E are detail diagrams showing another example progression of game play on a pattern display of a gaming device according to embodiments of the invention.

FIGS. 9A, 9B, 9C, 9D, and 9E are detail diagrams showing yet another example progression of game play on a pattern display of a gaming device according to embodiments of the invention.

FIGS. 10A and 10B are detail diagrams of pattern displays showing different types of patterns associated with game play on a gaming device according to embodiments of the invention.

FIG. 11 is a flow diagram showing a method of operating a gaming device having a pattern display according to embodiments of the invention.

FIG. 12 is a flow diagram showing another method of operating a gaming device having a pattern display according to embodiments of the invention.

FIG. 13 is a flow diagram showing methods of updating a pattern display according to embodiments of the invention.

FIG. 14 is a flow diagram showing methods of displaying a pattern display according to embodiments of the invention.

FIG. 15 is a flow diagram showing methods of altering a pattern display according to embodiments of the invention.

FIG. 16 is a flow diagram showing another method of operating a gaming device having a pattern display according to embodiments of the invention.

FIG. 17 is a detail diagram of a gaming device having a bonus pattern display according to embodiments of the invention.

FIG. 18 is a flow diagram showing a method of operating a gaming device having a bonus pattern display according to embodiments of the invention.

FIG. 19 is a flow diagram showing another method of operating a gaming device having a bonus pattern display according to embodiments of the invention.

### DETAILED DESCRIPTION

Embodiments of the present invention are directed to gaming devices having a pattern display associated with game play on the gaming device, and methods of operating the gaming device to generate, modify, and interact with a pattern on the pattern display. Various embodiments of this concept use a pattern game display to determine base game and/or bonus awards during game play on the gaming device. As will be discussed in detail below, this may include displaying an initial pattern, modifying the initial pattern as play on the gaming device progresses, and determining if a modified pattern is associated with an award. The displayed pattern may be presented on any display device, including but not limited to the game screen or on any screen or panel on a gaming device, in a secondary display device attached or detached from the gaming device or table game, or any other display applications used on or with a gaming device or table.

Patterns may show a visual image that includes multiple pattern elements that make up the image and have various visual states. For example, a pattern may include multiple tiles that show a background or blank image in an “unrevealed” state and show a portion of the pattern image in a “revealed” state. In this example, when all pattern elements are in a revealed state, the full image of the pattern may be shown. In another example, the pattern may include a fixed base image, and have multiple pattern elements that can appear on the pattern display in relation to the fixed base image. Again, these pattern elements may have multiple visual states. For example, these pattern elements may have an “unrevealed” state where they do not appear at all on the pattern display, a first state where they are shown with a particular visual styling, and a second state when they are shown with another visual styling or at a different location. In this application, pattern elements are referred to interchangeably as marks, tiles, elements, and other terms specific to discussed embodiments.

In some embodiments, these patterns may be generated by randomly assigning or modifying elements or marks to a pattern display at periodic intervals, at random, in response to a game event, or in response to another pattern modification signal. In other embodiments, patterns may be generated by randomly assigning a mark within a predetermined boundary or range within a pattern display in response to a game outcome or other game event. The predetermined boundary or range may include portions of a player selected, or otherwise predetermined, symbol that is modified by the pattern markings. Some of these embodiments further allow a player to manipulate the pattern display to alter the current pattern, change the type of pattern shown, reset the pattern, or view a historical progression of the pattern to its current state.

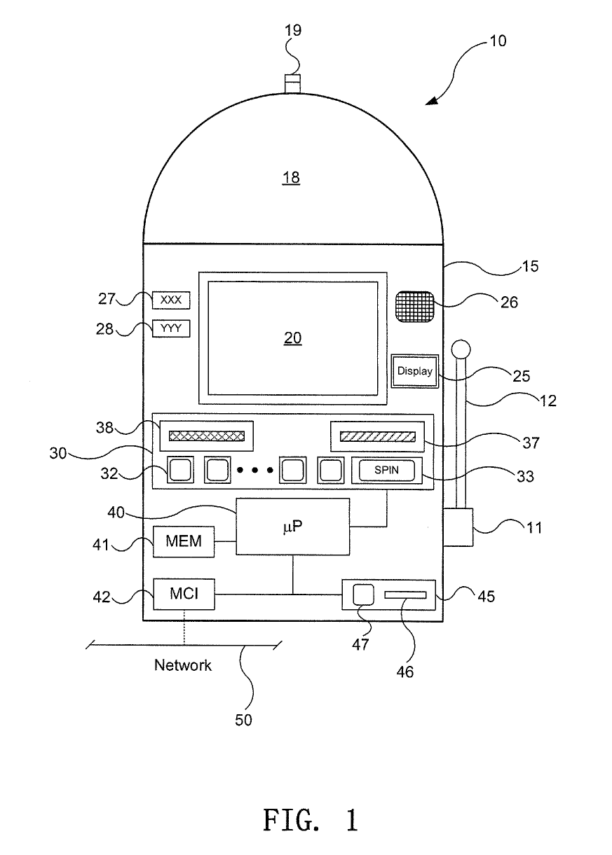

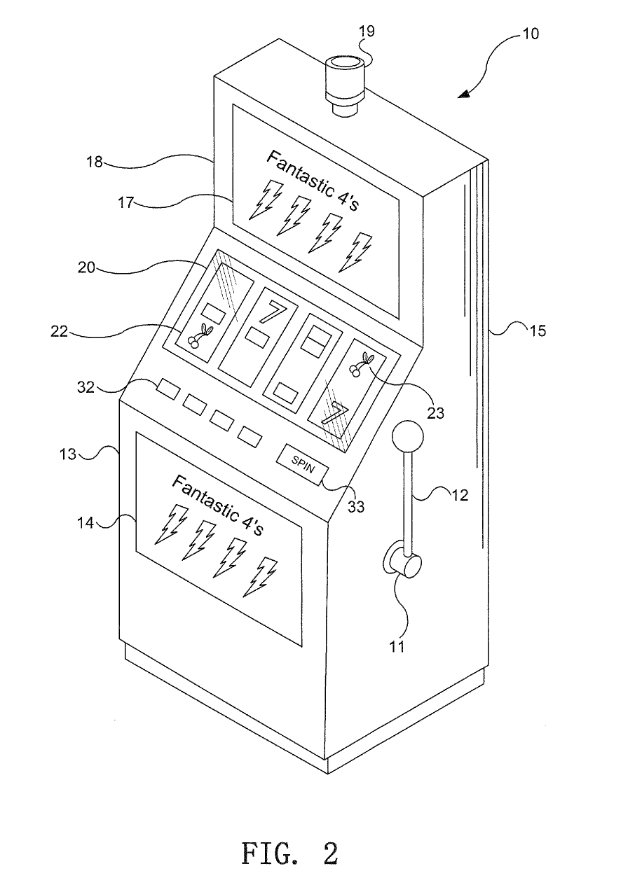

FIGS. 1 and 2 illustrate example gaming devices according to embodiments of the invention.

Referring to FIGS. 1 and 2, a gaming device 10 is an electronic gaming machine. Although an electronic gaming machine or “slot” machine is illustrated, various other types of devices may be used to wager monetarily based credits on a game of chance in accordance with principles of the invention. The term “electronic gaming device” is meant to include various devices such as electro-mechanical spinning-reel type slot machines, video slot machines, and video poker machines, for instance. Other gaming devices may include computer-based gaming machines, wireless gaming devices, multi-player gaming stations, modified personal electronic gaming devices (such as cell phones), personal computers, server-based gaming terminals, lottery devices, and other similar devices. Although embodiments of the invention will work with all of the gaming types mentioned, for ease of illustration the present embodiments will be described in reference to the electronic gaming machine 10 shown in FIGS. 1 and 2.

The gaming device 10 includes a cabinet 15 housing components to operate the gaming device 10. The cabinet 15 may include a gaming display 20, a base portion 13, a top box 18, and a player interface panel 30. The gaming display 20 may include mechanical spinning reels, a video display, or a combination of both spinning reels and a video display. The gaming cabinet 15 may also include a credit meter 27 and a coin-in or bet meter 28. The credit meter 27 may indicate the total number of credits remaining on the gaming device 10 that are eligible to be wagered. In some embodiments, the credit meter 27 may reflect a monetary unit, such as dollars. However, it is often preferable to have the credit meter 27 reflect a number of ‘credits,’ rather than a monetary unit. The bet meter 28 may indicate the amount of credits to be wagered on a particular game. Thus, for each game, the player transfers the amount that he or she wants to wager from the credit meter 27 to the bet meter 28. In some embodiments, various other meters may be present, such as meters reflecting amounts won, amounts paid, or the like. In embodiments where the gaming display 20 is a video monitor, the information indicated on the credit meters may be shown on the gaming display itself 20.

The base portion 13 may include a lighted panel 14, a coin return (not shown), and a gaming handle 12 operable on a partially rotating pivot joint 11. The game handle 12 is traditionally included on mechanical spinning-reel games, where the handle may be pulled toward a player to initiate the spinning of reels 22 after placement of a wager. The top box 18 may include a lighted panel 17, a video display (such as an LCD monitor), a mechanical bonus device (not shown), and a candle light indicator 19. The player interface panel 30 may include various devices so that a player can interact with the gaming device 10.

The player interface panel 30 may include one or more game buttons 32 that can be actuated by the player to cause the gaming device 10 to perform a specific action. For example, some of the game buttons 32 may cause the gaming device 10 to bet a credit to be wagered during the next game, change the number of lines being played on a multi-line game, cash out the credits remaining on the gaming device (as indicated on the credit meter 27), or request assistance from casino personnel, such as by lighting the candle 19. In addition, the player interface panel 30 may include one or more game actuating buttons 33. The game actuating buttons 33 may initiate a game with a pre-specified amount of credits. On some gaming devices 10 a “Max Bet” game actuating button 33 may be included that places the maximum credit wager on a game and initiates the game. The player interface panel 30 may further include a bill acceptor 37 and a ticket printer 38. The bill acceptor 37 may accept and validate paper money or previously printed tickets with a credit balance. The ticket printer 38 may print out tickets reflecting the balance of the credits that remain on the gaming device 10 when a player cashes out by pressing one of the game buttons 32 programmed to cause a ‘cashout.’ These tickets may be inserted into other gaming machines or redeemed at a cashier station or kiosk for cash.

The gaming device 10 may also include one or more speakers 26 to transmit auditory information or sounds to the player. The auditory information may include specific sounds associated with particular events that occur during game play on the gaming device 10. For example, a particularly festive sound may be played during a large win or when a bonus is triggered. The speakers 26 may also transmit “attract” sounds to entice nearby players when the game is not currently being played.

The gaming device 10 may further include a secondary display 25. This secondary display 25 may be a vacuum fluorescent display (VFD), a liquid crystal display (LCD), a cathode ray tube (CRT), a plasma screen, or the like. The secondary display 25 may show any combination of primary game information and ancillary information to the player. For example, the secondary display 25 may show player tracking information, secondary bonus information, advertisements, or player selectable game options. The gaming device 10 may include a separate information window (not shown) dedicated to supplying any combination of information related to primary game play, secondary bonus information, player tracking information, secondary bonus information, advertisements or player selectable game options. This window may be fixed in size and location or may have its size and location vary temporally as communication needs change. One example of such a resizable window is International Game Technology's “service window.” Another example is Las Vegas Gaming Incorporated's retrofit technology which allows information to be placed over areas of the game or the secondary display screen at various times and in various situations.

The gaming device 10 includes a microprocessor 40 that controls operation of the gaming device 10. If the gaming device 10 is a standalone gaming device, the microprocessor 40 may control virtually all of the operations of the gaming devices and attached equipment, such as operating game logic stored in memory (not shown) as firmware, controlling the display 20 to represent the outcome of a game, communicating with the other peripheral devices (such as the bill acceptor 37), and orchestrating the lighting and sound emanating from the gaming device 10. In other embodiments where the gaming device 10 is coupled to a network 50, as described below, the microprocessor 40 may have different tasks depending on the setup and function of the gaming device. For example, the microprocessor 40 may be responsible for running the base game of the gaming device and executing instructions received over the network 50 from a bonus server or player tracking server. In a server-based gaming setup, the microprocessor 40 may act as a terminal to execute instructions from a remote server that is running game play on the gaming device.

The microprocessor 40 may be coupled to a machine communication interface (MCI) 42 that connects the gaming device 10 to a gaming network 50. The MCI 42 may be coupled to the microprocessor 40 through a serial connection, a parallel connection, an optical connection, or in some cases a wireless connection. The gaming device 10 may include memory 41 (MEM), such as a random access memory (RAM), coupled to the microprocessor 40 and which can be used to store gaming information, such as storing total coin-in statistics about a present or past gaming session, which can be communicated to a remote server or database through the MCI 42. The MCI 42 may also facilitate communication between the network 50 and the secondary display 25 or a player tracking unit 45 housed in the gaming cabinet 15.

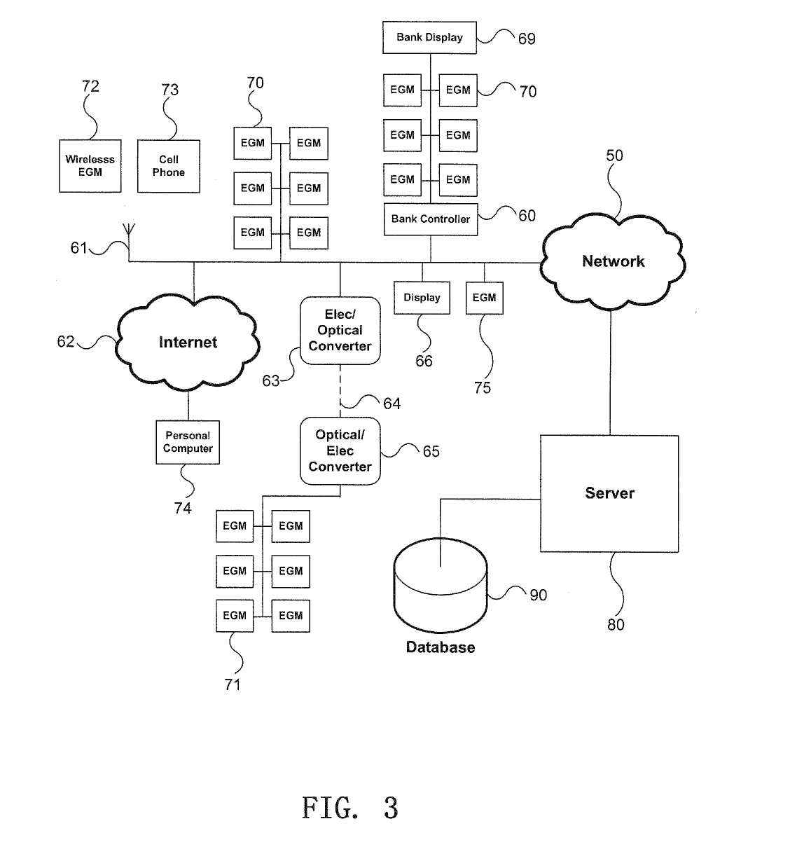

The player tracking unit 45 may include an identification device 46 and one or more buttons 47 associated with the player tracking unit 45. The identification device 46 serves to identify a player, by, for example, reading a player-tracking device, such as a player tracking card that is issued by the casino to individual players who choose to have such a card. The identification device 46 may instead, or additionally, identify players through other methods. Player tracking systems using player tracking cards and card readers 46 are known in the art. Briefly summarizing such a system, a player registers with the casino prior to commencing gaming. The casino issues a unique player-tracking card to the player and opens a corresponding player account that is stored on a server or host computer, described below with reference to FIG. 3. The player account may include the player's name and mailing address and other information of interest to the casino in connection with marketing efforts. Prior to playing one of the gaming devices in the casino, the player inserts the player tracking card into the identification device 46 thus permitting the casino to track player activity, such as amounts wagered, credits won, and rate of play.

To induce the player to use the card and be an identified player, the casino may award each player points proportional to the money or credits wagered by the player. Players typically accrue points at a rate related to the amount wagered, although other factors may cause the casino to award the player various amounts. The points may be displayed on the secondary display 25 or using other methods. In conventional player tracking systems, the player may take his or her card to a special desk in the casino where a casino employee scans the card to determine how many accrued points are in the player's account. The player may redeem points for selected merchandise, meals in casino restaurants, or the like, which each have assigned point values. In some player tracking systems, the player may use the secondary display 25 to access their player tracking account, such as to check a total number of points, redeem points for various services, make changes to their account, or download promotional credits to the gaming device 10. In other embodiments, the identification device 46 may read other identifying cards (such as driver licenses, credit cards, etc.) to identify a player and match them to a corresponding player tracking account. Although FIG. 1 shows the player tracking unit 45 with a card reader as the identification device 46, other embodiments may include a player tracking unit 45 with a biometric scanner, PIN code acceptor, or other methods of identifying a player to pair the player with their player tracking account.

During typical play on a gaming device 10, a player plays a game by placing a wager and then initiating a gaming session. The player may initially insert monetary bills or previously printed tickets with a credit value into the bill acceptor 37. The player may also put coins into a coin acceptor (not shown) or a credit, debit or casino account card into a card reader/authorizer (not shown). One of skill in the art will readily see that this invention is useful with all gambling devices, regardless of the manner in which wager value-input is accomplished.

The credit meter 27 displays the numeric credit value of the money inserted dependent on the denomination of the gaming device 10. That is, if the gaming device 10 is a nickel slot machine and a $20 bill inserted into the bill acceptor 37, the credit meter will reflect 400 credits or one credit for each nickel of the inserted twenty dollars. For gaming devices 10 that support multiple denominations, the credit meter 27 will reflect the amount of credits relative to the denomination selected. Thus, in the above example, if a penny denomination is selected after the $20 is inserted the credit meter will change from 400 credits to 2000 credits.

A wager may be placed by pushing one or more of the game buttons 32, which may be reflected on the bet meter 28. That is, the player can generally depress a “bet one” button (one of the buttons on the player interface panel 30, such as 32), which transfers one credit from the credit meter 27 to the bet meter 28. Each time the button 32 is depressed an additional single credit transfers to the bet meter 28 up to a maximum bet that can be placed on a single play of the electronic gaming device 10. The gaming session may be initiated by pulling the gaming handle 12 or depressing the spin button 33. On some gaming devices 10, a “max bet” button (another one of the buttons 32 on the player interface panel 30) may be depressed to wager the maximum number of credits supported by the gaming device 10 and initiate a gaming session.

If the gaming session does not result in any winning combination, the process of placing a wager may be repeated by the player. Alternatively, the player may cash out any remaining credits on the credit meter 27 by depressing the “cash-out” button (another button 32 on the player interface panel 30), which causes the credits on the credit meter 27 to be paid out in the form of a ticket through the ticket printer 38, or may be paid out in the form of returning coins from a coin hopper (not shown) to a coin return tray.

If instead a winning combination (win) appears on the display 20, the award corresponding to the winning combination is immediately applied to the credit meter 27. For example, if the gaming device 10 is a slot machine, a winning combination of symbols 23 may land on a played payline on reels 22. If any bonus games are initiated, the gaming device 10 may enter into a bonus mode or simply award the player with a bonus amount of credits that are applied to the credit meter 27.

FIG. 3 is a block diagram illustrating networked gaming devices according to embodiments of the invention. Referring to FIG. 3, multiple electronic gaming devices (EGMs) 70, 71, 72, 73, 74, and 75 may be coupled to one another and coupled to a remote server 80 through a network 50. For ease of understanding, gaming devices or EGMs 70, 71, 72, 73, 74, and 75 are generically referred to as EGMs 70-75. The term EGMs 70-75, however, may refer to any combination of one or more of EGMs 70, 71, 72, 73, 74, and 75. Additionally, the gaming server 80 may be coupled to one or more gaming databases 90. These gaming network 50 connections may allow multiple gaming devices 70-75 to remain in communication with one another during particular gaming modes such as tournament play or remote head-to-head play.

The gaming devices 70-75 may include traditional slot machines 75 directly coupled to the network 50, banks of gaming devices 70 coupled to the network 50, banks of gaming devices 70 coupled to the network through a bank controller 60, wireless handheld gaming machines 72 and cell phones 73 coupled to the gaming network 50 through one or more wireless routers or antennas 61, personal computers 74 coupled to the network 50 through the internet 62, and banks of gaming devices 71 coupled to the network through one or more optical connection lines 64. Additionally, some of the traditional gaming devices 70, 71, and 75 may include electronic gaming tables, multi-station gaming devices, or electronic components operating in conjunction with non-gaming components, such as automatic card readers, chip readers, and chip counters, for example.

Gaming devices 71 coupled over an optical line 64 may be remote gaming devices in a different location or casino. The optical line 64 may be coupled to the gaming network 50 through an electronic to optical signal converter 63 and may be coupled to the gaming devices 71 through an optical to electronic signal converter 65. The banks of gaming devices 70 coupled to the network 50 may be coupled through a bank controller 60 for compatibility purposes, for local organization and control, or for signal buffering purposes. The network 50 may include serial or parallel signal transmission lines and carry data in accordance with data transfer protocols such as Ethernet transmission lines, Rs-232 lines, firewire lines, USB lines, or other communication protocols. Although not shown in FIG. 3, substantially the entire network 50 may be made of fiber optic lines or may be a wireless network utilizing a wireless protocol such as IEEE 802.11a, b, g, or n, Zigbee, RF protocols, optical transmission, near-field transmission, or the like.

Gaming displays 66, 69 may also be connected to the server 80 through the network 50. These displays 66, 69 may be common gaming displays that show game information relating to multiple gaming devices 70-75, such as linked bonuses, multiple game station outcomes, or the like. Alternatively, the displays 66, 69 may show promotional casino information, advertisements, or other information that is to be communicated to players. The displays may be stand alone displays 66 directly connected to the network 50 or bank displays 69 connected to the network 50 through a bank controller 60.

As mentioned above, each gaming device 70-75 may have an individual processor 40 (FIG. 1) and memory 41 to run and control game play on the gaming device 70-75, or some of the gaming devices 70-75 may be terminals that are run by a remote server 80 in a server based gaming environment. Server based gaming environments may be advantageous to casinos by allowing fast downloading of particular game types or themes based on casino preference or player selection. Additionally, tournament based games, linked games, and certain game types, such as BINGO or keno may benefit from at least some server 80 based control.

Thus, in some embodiments, the network 50, server 80, and database 90 may be dedicated to communications regarding specific game or tournament play. In other embodiments, however, the network 50, server 80, and database 90 may be part of a player tracking network. For player tracking capabilities, when a player inserts a player tracking card in the card reader 46 (FIG. 1), the player tracking unit 45 sends player identification information obtained on the card reader 46 through the MCI 42 over the network 50 to the player tracking server 80, where the player identification information is compared to player information records in the player database 90 to provide the player with information regarding their player account or other features at the gaming device 10 where the player is wagering. Additionally, multiple databases 90 and/or servers 80 may be present and coupled to one or more networks 50 to provide a variety of gaming services, such as both game/tournament data and player tracking data.

The various systems described with reference to FIGS. 1-3 can be used in a number of ways. For instance, the systems can be used to track data about various players. The tracked data can be used by the casino to provide additional benefits to players, such as extra bonuses or extra benefits such as bonus games and other benefits as described above. These added benefits encourage players to play at a particular casino that provides benefits rather than another casino or gaming establishment.

The gaming devices and systems shown in FIGS. 1-3 can be configured to implement game play that includes elements of modifying displayed patterned images in order to win awards. In this disclosure, these patterned images are referred to as “patterns” and include any type of game play display that can add, remove, or change visual elements to further game play. Often times, these visual elements can be portions of a larger symbol or picture, or may otherwise have a visual basis that appears to be pattern-like. As players often relate to visual cues or perceived patterns, these type of gaming devices and systems have a wide appeal to players that may further their enjoyment during game play. These patterns are distinct and different from conventional slot, video poker, or keno games in that they do not rely on a combination of symbols, cards, or numbers, but rather visual elements that are part of a larger overall image or display. Hence, game play does not necessarily revolve around a single spinning of reels, poker hand, or keno draw; rather, the game play incorporates the visual elements into a game where the number and/or properties of the visual elements determine awards over multiple game plays. While the visual elements in the patterns may shift or change between game events, the patterns themselves include constants that span these game events. Even when, for example, a player resets a pattern after a single play, or redeems an award after a single play, the pattern is capable of continuing to be part of a larger series of games. For ease of reference, a series of games concerning a single pattern is referred to as a “pattern-game series” in this disclosure. A pattern-game series in some embodiments includes an initial pattern that is modified during game play for multiple games if it is not reset or otherwise ended by a player choice. In other embodiments, a pattern-game series may include multiple opportunities to complete a pattern, or add/remove pattern elements to achieve a goal and win awards.

These patterns can be the base game of a gaming device or can be a secondary or bonus game that interacts with a more conventional base game. A base game is the basic or primary part of a game that is wagered on and played by a player. A secondary game, on the other hand, is an additional game that is played from time to time during play of the base game. Secondary games may be triggered by parts of the base game, may be awarded at random, or may be part of a mystery-styled bonus game. Gaming devices that include pattern-based base game play is discussed first below with several illustrated embodiments, and then gaming devices that include a pattern-based secondary game is discussed.

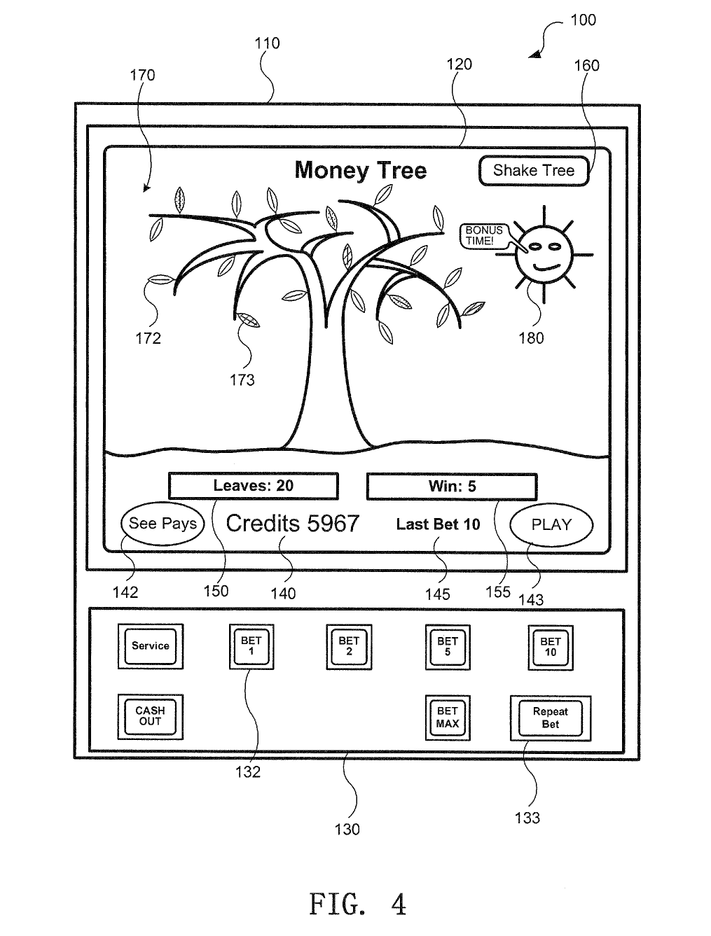

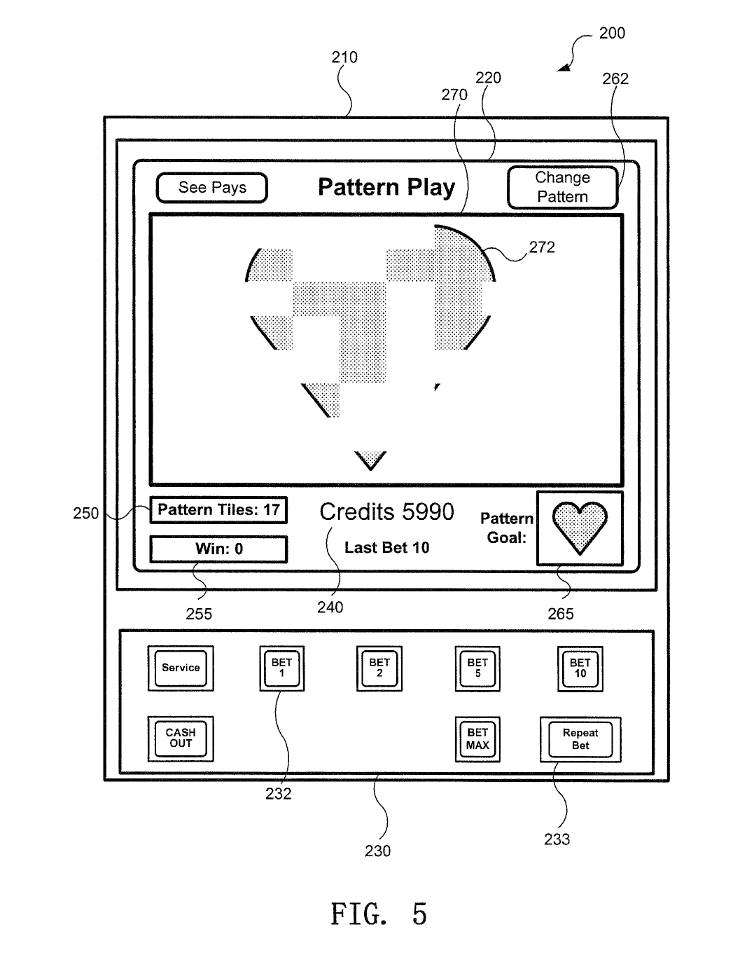

For base game pattern play, various types of displays may be used with differing goals that player's attempt to achieve in order to win prizes. In some embodiments, the patterns revolve around adding visual elements to an image to generate prizes (e.g., FIG. 4). In other embodiments, the patterns revolve around completing a symbol or image (e.g., FIG. 5). In yet other embodiments, the patterns revolve around removing blocks or tiles to reveal a symbol or image (FIG. 6). Various other types of image manipulation can be used to create pattern game play, as well, and these variations are included within the scope of this disclosure.

FIG. 4 is a detail diagram of a gaming device 100 having a pattern display 170 according to embodiments of the invention. The pattern game play for the gaming device 100 shown in FIG. 4 focuses on obtaining as many visual elements on an image as possible, although the visual elements may have unique identifying properties that are related to their respective values.

Referring to FIG. 4, a gaming device 100 having a game cabinet 110 includes a display 120 and a player interface panel 130. The display 120 may include a pattern display 170 that shows a pattern-base game. When this display is used as the base game of a gaming device, such as in this embodiment, it may also be referred to as a gaming display or game display. The player interface panel 130 includes game buttons 132, and one or more game initiation buttons 133 to facilitate game play on the gaming device 100. The pattern display 120 is configured to show a conglomeration of visual elements, such as shapes, shades, colors, and/or other objects arranged in a specific area that may lend itself to a show a pattern discernible by a player.

The arrangement of visual objects shown on the pattern display 170 not only are associated with a paytable and corresponding awards, but may also be interpreted by a player as containing a recognizable pattern that may influence the player to play or not to play the gaming device 110, or to change their wager size, change their betting style, or otherwise influence their behavior. For example, a player may associate a type of symbol or pattern shown on the pattern display 170 with good luck, and decide to begin game play or alter their game play based on the image. Additionally, if a player notices similar pattern elements to ones where they have previously won prizes, they may alter their game play. In embodiments where the player can manipulate the pattern, the player may further attempt to manipulate the pattern so that it resembles the previously noted pattern.

Because superstition is frequently associated with gambling activities, players often look for “signs” to determine if a game is lucky or not. However, most game setups (cabinets, glass, signage, coverings, etc.) are consistent due to manufacturing considerations and the difficulty in varying aspects of the gaming hardware. Players may of course feel that one theme or type of gaming device is luckier than another, but choosing between similar gaming device themes or types may be more difficult. The pattern display 170 not only provides a unique and different gaming experience, it also provides players with another means to differentiate between gaming devices.

It is human nature to recognize patterns or familiar symbols when presented with an arrangement of objects in apparent disorder. Constellations of stars, recognized fluffy cloud animals, and purported images found in hillsides or pieces or rock are just a few examples of people “finding” something familiar in an arrangement of objects. The pattern display 170 provides a similar “canvas” or medium with which to present a player with an arrangement of objects that may produce a perceivable image, symbol, or other recognizable pattern (collectively referred to as a pattern herein). This arrangement of objects in the pattern display 170 may be modified with each game event during game play or at various intervals when the gaming device is not being played. As the pattern changes, perceived objects may morph, disappear, appear, or otherwise change, which may provide different influences on a current player or other prospective players.

The pattern display 170 may include a presentation of images or a collection of marks created at random or associated with an aspect of a game outcome. To facilitate pattern creation, the pattern display may include a plurality of addresses at which a mark can be assigned. In some embodiments, these marks are randomly assigned by a game RNG or secondary RNG included in the microprocessor 40 (FIG. 1) of the gaming device 110 to an address or other defined portion of the pattern display. These marks may include a random selection between a plurality of different mark types or mark colors, which may add variety or complexity to the pattern image created by the accumulation of marks. Additionally, if a portion of the pattern display 170 for which a new mark is assigned already includes an existing mark, the new mark may replace the existing mark (i.e., the old mark is removed, and the new mark takes it place), or the existing mark may be modified by the new mark. For example, the leaves on the money tree may change color, shape, or appearance. These changes may be associated with different awards or may only change to alter the visual impact of the overall pattern.

If a pattern display 170 has a threshold number of marks that may be presented at any given time, such as a maximum number of leaves on the money tree, the placement of a new mark may require the removal of another existing mark. The existing mark to be removed may be identified at random, or may be chosen using an algorithm or set of rules, such as the removal of the mark with the closest proximity to the new mark, removal of the oldest existing mark (FIFO—First In First Out), or removal according to another scheme. The pattern display 170 may be modified (i.e., marks may be generated or modified) at periodic intervals, at random, in response to a game event, or in response to another pattern modification signal.

In other embodiments, patterns may be generated by randomly assigning a mark within a predetermined boundary or range within the pattern display 170 in response to a game outcome or other game event. The predetermined boundary or range may include portions of player selected or otherwise predetermined symbol that is modified by the pattern markings. That is, a symbol or image may be presented in a specific shape, such as the branches of the money tree, or in an outlined or other format on the pattern display with identified portions (or address) ranges corresponding to game outcomes. For example, portions of the symbol may be tied to sizes or categories of outcomes. Although specific addresses of the pattern display 170 may be associated with particular game outcomes, ranges of addresses may preferably be associated with the game outcomes where the specific address of the modification is chosen at random within the address range so that the element of randomness is maintained with the generation of the pattern image on the pattern display 170.

In some embodiments, game outcomes may be assigned different weights that generate more or less marks. For example, outcomes that fall into a higher range may trigger three leaves or marks to be generated and used to modify the pattern display 170, while lower range outcomes may generate only two or one mark used to modify the pattern display.

The pattern display 170 shown in this embodiment is a money tree that has pattern of leaves 172, 173 on it. A leaf meter 150 keeps track of the number of leaves on the tree, and a win meter 155 displays a win value associated with the pattern of leaves 172, 173. A play button 143 may be used instead of the game initiation button 133 on the player interface panel 130 to begin a new gaming event. Other game buttons, such as a see pays button 142 may also be included on a display 120 to help game play. A last bet meter 145 and a credit meter 140 are also included to provide important game information to a player. In this embodiment, the leaves 172, 173 of the tree may have different colors or patterns, which may be associated with different credit values, or have other game play properties. For example, plain leaves 172 may be counted only once toward an award, but patterned leaves 173 are counted and provide a bonus credit award of one credit. During game play, some of the plain leaves 172 may turn into patterned leaves 173, or patterned leaves may fall off or turn back into plain leaves. New plain leaves may “sprout” from the tree branches, or otherwise become visible on the tree branches. Awards, may be generated by having the player accumulate a certain number of leaves on the tree, as tracked by the leaf meter 150, or may be associated with other aspects of game play. A bonus indicator 180 may appear from time to time to help new leaves 172 “grow” or age into patterned leaves 173. In some embodiments, the change in the leaves may be impacted by a seasonal change that is reflected in the game. For example, leaves may begin to show as buds with an initial value associated with them (spring), progress to full-sized leaves with a different value during a “summer,” begin to change colors with yet another associated value (fall), and finally drop to the ground and disappear during a “winter” where their value is added to a player's credit meter, or where they lose any value. These “seasonal” changes may be visually powerful method of game play that is both intuitive to a player and interesting to play.

While this embodiment shows a tree with leaf patterns, various other types of patterns may be shown on the pattern display according to game type, player preference, game/casino theme, etc. Several other types of pattern games and pattern types are shown in FIGS. 5, 6, 10A, 10B, etc. However, these are merely examples of types of patterns that may be used. The present inventive concept covers all types of displayed object arrangements.

The pattern on the pattern display 170 may also be manipulated or changed by a player in some embodiments. These operations may include manipulating an aspect of the current pattern or selecting a new type of pattern to show on the pattern display. These operations may be carried out by a player input on the pattern display 170 (e.g., touching the pattern display) or may have a separate player button 160, such as a shake tree button associated with the action. In this instance, the shake tree button 160 may be pressed to blow a wind or otherwise shake the tree in order to change the leaf types and positions on the money tree. For example, the shake tree button 160 may become active to be pressed randomly, or every 10 games. Pressing this button 160 may effectively reset the leaf pattern, or may have varied influences on the current leaf patterns, ranging from not changing the leaf patterns at all to completely blowing all the current leaves away and replacing them with new leaves. In some embodiments, the shake tree button 160 may only be activated with a side bet, or based on a player's status or on game conditions.

In other embodiments where the pattern display 170 may be manipulated by a player, the player may be able to zoom in (or out) on a portion of the pattern, rotate the pattern, stretch/shrink or crop the pattern, or otherwise change the appearance of the pattern. Alternately, the player may be able to change portions of the patterns, such as altering the shades or colors of a leaf 172, 173 or moving a pattern marking from place to another. Only certain players may be allowed to modify the pattern, such as identified players with a player account or players playing over a minimum average coin-in. Players may also have to “earn” the ability to modify a pattern. That is, a player may have to hit a certain number of symbols or symbol combinations, play for a predetermined amount of time, or meet another set of criteria to earn the ability to modify the pattern. A message may inform the player of this modification ability when it is activated, or the pattern may become highlighted or otherwise activated to bring the player's attention to this feature. A player may want to rearrange a portion of the pattern to better show a desirable symbol or image.

Pattern data used in the pattern display 170 may be maintained in the gaming device memory 41 (FIG. 1) or maintained in a remote database 90 (FIG. 3) connected to the gaming device via a network 50. Even when the pattern data is maintained in a remote database 90, the local gaming device memory 41 may be used to temporarily store recent modifications to the pattern data. This temporality stored data may be transferred to the remote database 90 periodically and/or in response to a triggering event, such as a player cashing out or otherwise ending a game session. Here, a remote server 80 (FIG. 3) and a game processor 40 (FIG. 1A) may be used to coordinate and otherwise facilitate this transfer of the pattern data. The server 80 may include a receiver, such as an input port, to receive pattern data recorded and/or stored at the gaming device 100. The server 80 may also include a processor that processes the updated pattern data and generates the visual depiction of the updated pattern data that is to be displayed to the player. A transfer unit may further be included in the server 80 to transfer this visual depiction to the gaming device 100 so that an updated image of the pattern data can be shown on the pattern display 170.

In some embodiments, the ability to provide a pattern display 170 may be downloaded to a gaming device 100 from a remote server 80 (FIG. 3) if requested by a player and/or if the player meets predetermined criteria. That is, a pattern play module may be transferred to a gaming device 100 to provide the gaming device instructions or directives for displaying a pattern display 170 on at least one of the existing displays associated with the gaming device 110. Here, the pattern play module may direct the gaming device to maintain pattern data as well as process and display the pattern data. Alternatively, the pattern play module may direct the game device to periodically transfer recorded pattern data to the server 80 to be processed and returned in a graphical form for display to a player as discussed above. By utilizing pattern play modules, existing gaming devices could be modified to provide a pattern display 170 to players. Pattern play modules may also be an option for a server based gaming environment where players download games to game device terminals.

There are several advantages of maintaining pattern data records on a remote database 90. These advantages include the flexibility of processing pattern data for a particular player over multiple game devices, for particular types of game devices, or even gaming devices spread across related casino properties. Here, the remote pattern data can be accessed by any gaming device that is connected to the remote server 80 and utilized in preparing a pattern display for a player of the gaming device 170.

FIG. 5 is a detail diagram of another gaming device 200 having a pattern display 270 according to embodiments of the invention.

Referring to FIG. 5, a pattern game is shown on a gaming device 200 having a gaming cabinet 210 that includes a display 220 and a player interface panel 230. The player interface panel 230 includes one or more game buttons 232 to provide game play functionality or options, and includes one or more game initiating buttons 233 to initiate gaming events on the gaming device 200. The display 220 includes a pattern display 270, which shows a pattern that is the object of game play on the gaming device 200. The display 220 also includes a credit meter 240, a win meter 255, and pattern tile meter 250. In addition, a goal pattern image 265 is shown on the display 220 to show what a completed pattern should look like.

In this embodiment, the purpose of the pattern game is to complete a pattern symbol. Here, a heart is the selected symbol to complete, and various pattern portions or tiles 272 are filled in to complete part of the pattern. As discussed above, the player may select a symbol or image to use in a pattern game that they feel is lucky or that they have some positive association with. To facilitate this player choice, a change pattern button 262 may be included on a game display.

In these embodiments the player may be able to choose from a menu of pattern styles or types. This feature may be useful for players that prefer certain types of patterns. As discussed above and illustrated in some of the following figures, many different types of patterns may be shown on the pattern display 170. When a new pattern is selected, a player may have the option to begin with a blank pattern, or an initial randomly generated pattern. Alternatively, a saved pattern associated with an identified player or game type may be imported and used. Pattern data from the last time a pattern type was selected may also be used in some embodiments.

FIG. 6 is a detail diagram of another gaming device 300 having a pattern display 370 according to embodiments of the invention.

Referring to FIG. 6, a pattern game is shown on a gaming device 300 having a gaming cabinet 310 that includes a display 320 and a player interface panel 330. The player interface panel 330 includes one or more game buttons 332 to provide game play functionality or options, and includes one or more game initiating buttons 333 to initiate gaming events on the gaming device 300. The display 320 includes a pattern display 370, which shows a pattern that is the object of game play on the gaming device 300. The display 320 also includes a credit meter 340, a win meter 355, and pattern tile meter 350.

In this embodiment, the purpose of the pattern game is to reveal a pattern symbol. Here, a double dollar sign is the selected symbol to reveal. This image is initially covered by blocking or opaque tiles 374. As these blocking tiles are removed, the underlying pattern tiles 372 are revealed. The pattern tile meter 350 reflects the number of pattern tiles 372 that are revealed.

To reset the pattern, a player may use the “Reset Pattern” button 363 on the game display 320. Although this button 363 is shown as a soft button in the embodiment illustrated in FIG. 6, the “Reset Pattern” button may be a physical input device on the player interface panel 330 or may be linked to one of the game buttons 332. When the Reset Pattern button 363 is activated, a current pattern shown on the pattern display 370 may be altered to show no pattern where the pattern image is completely covered by blocking tiles 374, or to show a blank image in embodiments where a pattern is to be completed such as in FIG. 5. That is, in some embodiments, a pattern reset operation acts to completely remove any progress toward a pattern on the pattern display 170. With these embodiments, a player may be able to create a new pattern from essentially a blank slate. In other embodiments, a pattern reset operation acts to remove a current pattern and replace it with new randomly generated pattern. With these embodiments, shading and/or coloration remain after the reset operation, but they may not bear any relationship to a currently displayed pattern. This type of operation may be preferable to players that are looking for a new pattern without completely starting over.

How the Reset Pattern button operates may be fixed by a game design, or may be determinable by a casino operator or a player. If the gaming device 100 is configured to allow the player to choose the type of reset operation, a player preference for reset operations may be saved in a player account if the player is an indentified player. In some embodiments, the player may choose how the pattern is reset by separate input operations. For example, the player may briefly press the Reset Pattern button 363 to scramble the blocking tiles 374 to show different (but same number of) pattern tiles 372, or they may hold the Reset Pattern button 124 down continuously for three seconds to cover all pattern markings 372 on the pattern display 370. In another example, pressing the Reset Pattern button 363 may bring up a dialog box or window asking the player whether they want to generate a new random pattern or cover all of the pattern markings.

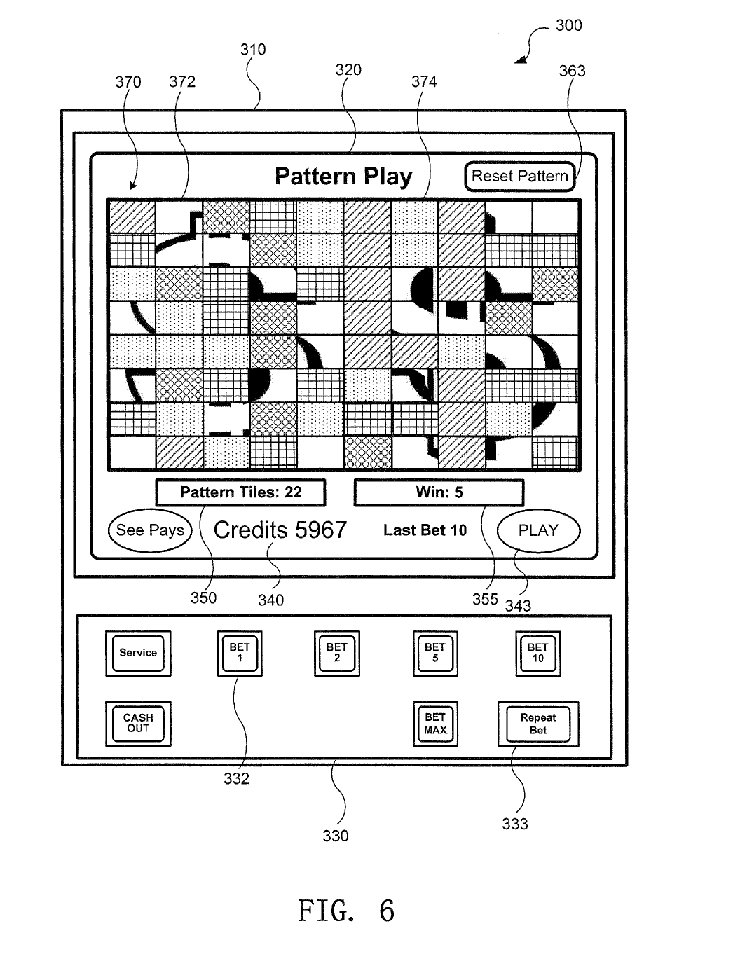

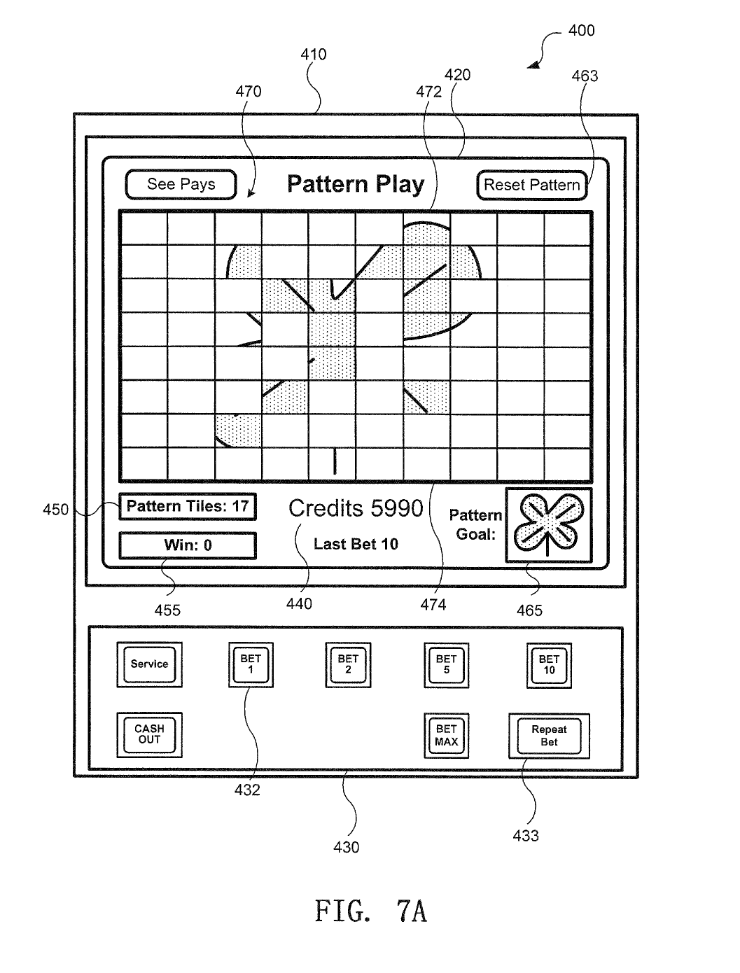

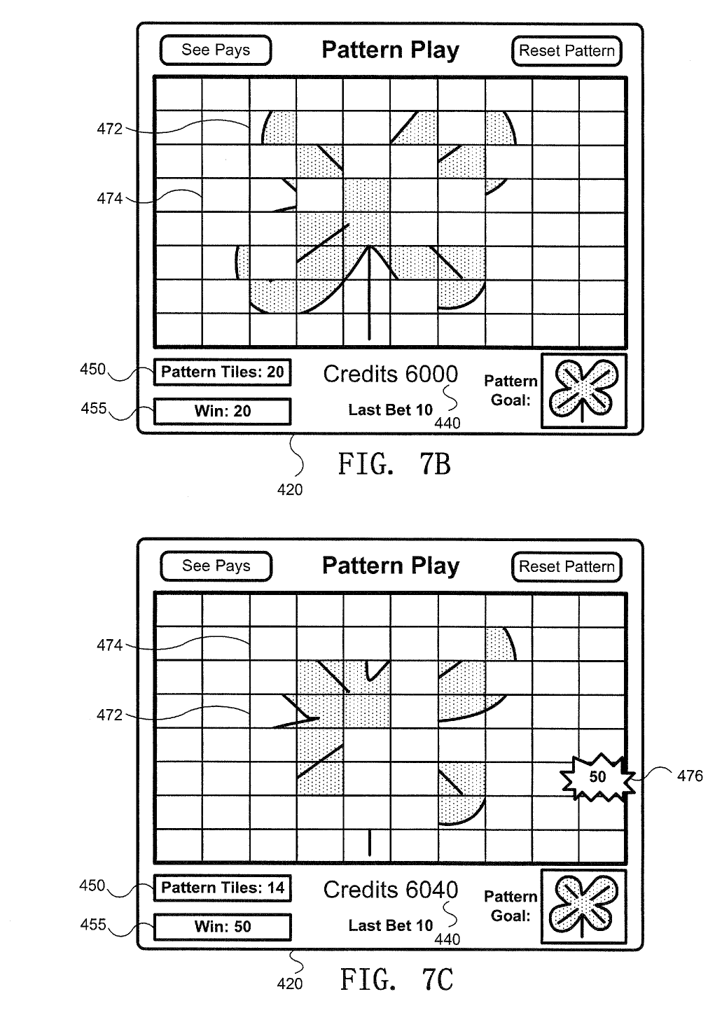

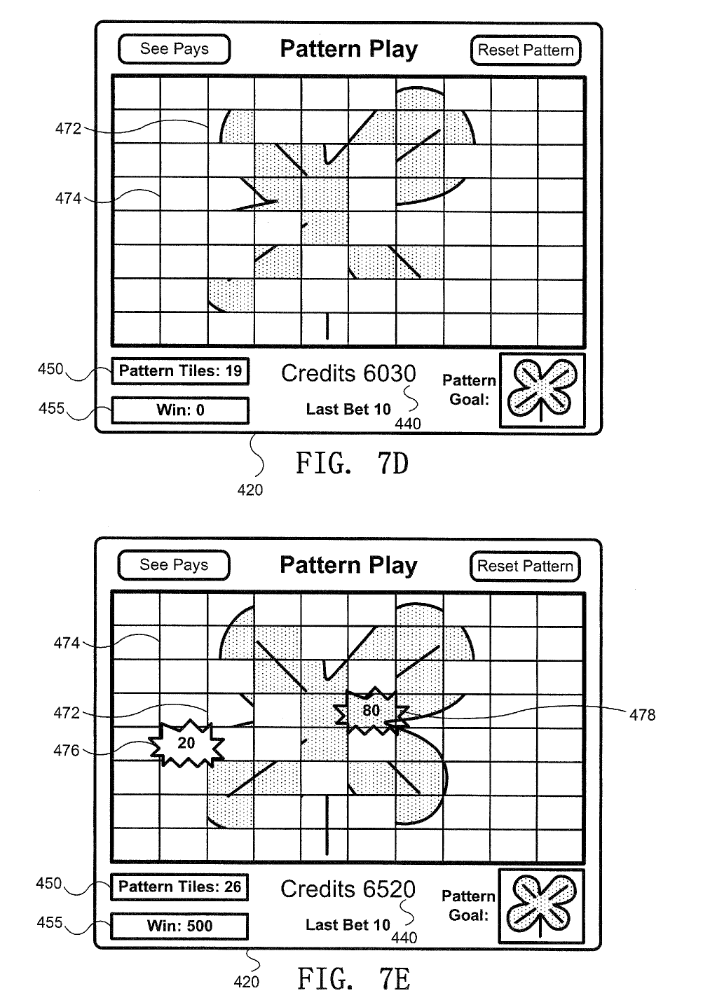

FIGS. 7A-7E, 8A-8E, and 9A-9E are example game play progressions of gaming devices having pattern-based game play. Multiple elements of game play are discussed in each of the example progressions. Various embodiments of gaming devices having pattern-based game play may include different game play elements and/or may include various portions of the elements shown in these three example game play progressions. For ease of understanding, each of these progressions is shown on a similar type of pattern display. However, the goals and elements of game play are different on each progression.

FIGS. 7A, 7B, 7C, 7D, and 7E are detail diagrams showing an example progression of game play on a pattern display of a gaming device according to embodiments of the invention. In this first game play progression, the tiles of the pattern randomly change between each game play, where the goal is to get as many pattern tiles (tiles with a portion of the selected pattern on them) as possible. A paytable may include various prizes for a certain number of pattern tiles, such as illustrated in Table 1.

TABLE 1

| Number of Pattern Tiles | Award |
|---|---|
| 0-19 | 0 |
| 20 | 20 |
| 21 | 25 |
| 22-24 | 100 |
| 25-29 | 400 |
| 30-34 | 1000 |
| 35-39 | 5000 |
| 40-44 | 10,000 |
| 45 | 100,000 |

Referring to FIG. 7A, a gaming device 400 has a gaming cabinet 410 that includes a display 420 and a player interface panel 430 that includes one or more game buttons 432 and one or more game initiation buttons 433. The display 420 includes a pattern display 470, a credit meter 440, a pattern tile meter 450, a win meter 455, and a pattern goal image 465. In addition, the display includes one or more soft buttons that can be used to change game conditions or affect game play, such as a pattern reset button 463.

The pattern display 470 is a matrix style board that includes 80 game tiles. When activated, some of these game tiles are pattern tiles 472 that include a portion of goal pattern, while other tiles 474 do not include any portion of the pattern. Non-activated tiles can appear in areas where the pattern should be, but do not show the associated pattern image and are not counted as pattern tiles. The pattern tile meter 450 shows the current number of pattern tiles 472 that are activated and show a portion of the goal pattern.

In this embodiment, the game tiles are randomly activated during each game play. To illustrate this, FIG. 7A begins game play where a player has input 6000 credits into the gaming device and has placed a 10 credit wager on the first gaming event. The player may have previously chosen the goal image, uploaded the goal image, or let the gaming device choose a particular image prior to game play as discussed above. During this first game, 17 pattern tiles 472 have been activated on the pattern display to create portions of the goal pattern shown in the pattern goal display 465. However, as the paytable in Table 1 shows, there is no award associated with only 17 pattern tiles 472 and the credit meter 440 reflects that the player has lost their wagered 10 credits.

In FIG. 7B, the player again wagers 10 credits. This time the player receives 20 pattern tiles 472 and has a corresponding win of 20 credits as shown in the win meter 455. The credit meter 440 reflects that the player has wagered a total of 20 credits and has won a total of 20 credits.

In FIG. 7C, the player again wagers 10 credits. In this game, the player only receives 14 pattern tiles 472 and does not win any awards based on this total. However, one of the activated tiles 476 that is outside of the pattern image area reveals a mystery bonus prize of 50 credits. This tile may contain the complete pattern which then explodes or is otherwise highlighted to emphasize the credit win to the player. The win meter reflects the 50 credit bonus win and the credit meter reflects the updated total of credits the player has available to wager.

The player again wagers 10 credits in FIG. 7D, but the total number of pattern tiles falls below the prize threshold. Hence the player loses the wagered 10 credits as shown by the updated credit meter 440.

In FIG. 7E, the player wagers 10 credits and has a much better outcome. First of all the player receives 26 pattern tiles, which is good for 400 credits as shown in Table 1. Next, one of the activated tiles 476 outside the pattern area reveals a 20 credit bonus win. In addition, one of the activated tiles 478 in the pattern area reveals another 80 credit bonus win. Hence, the player wins 500 credits overall, which is reflected in the win meter 455 and updated credit meter 440.

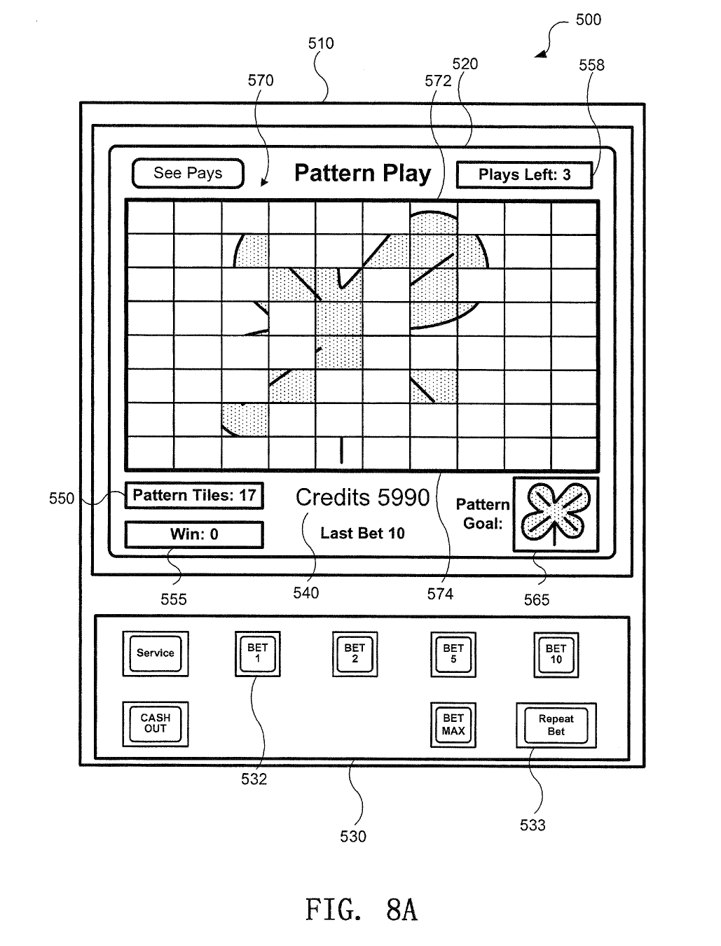

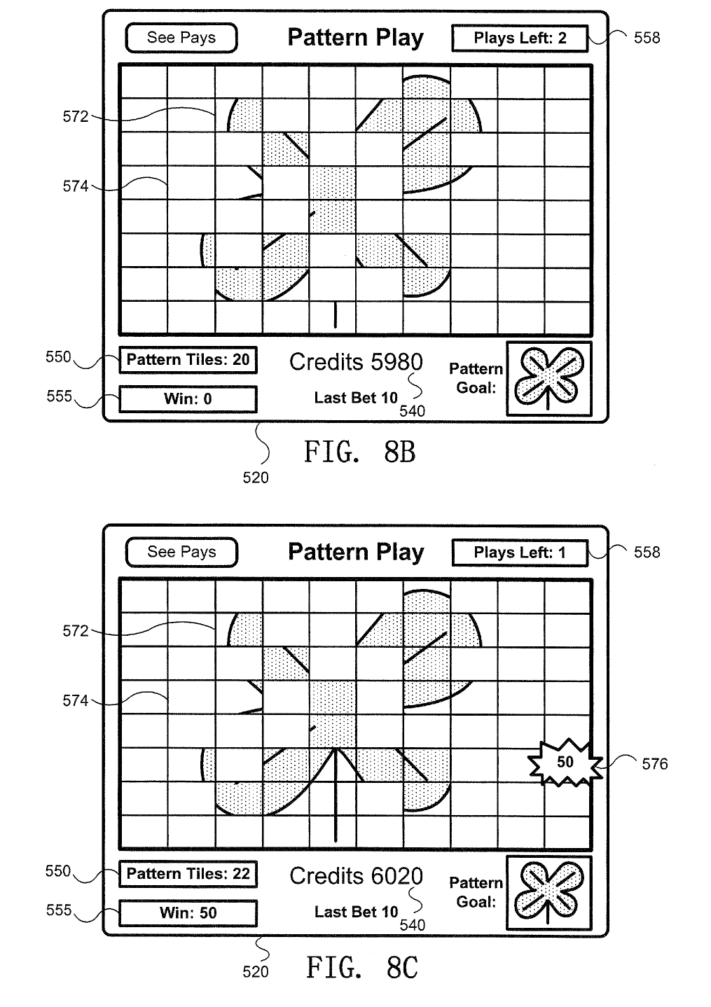

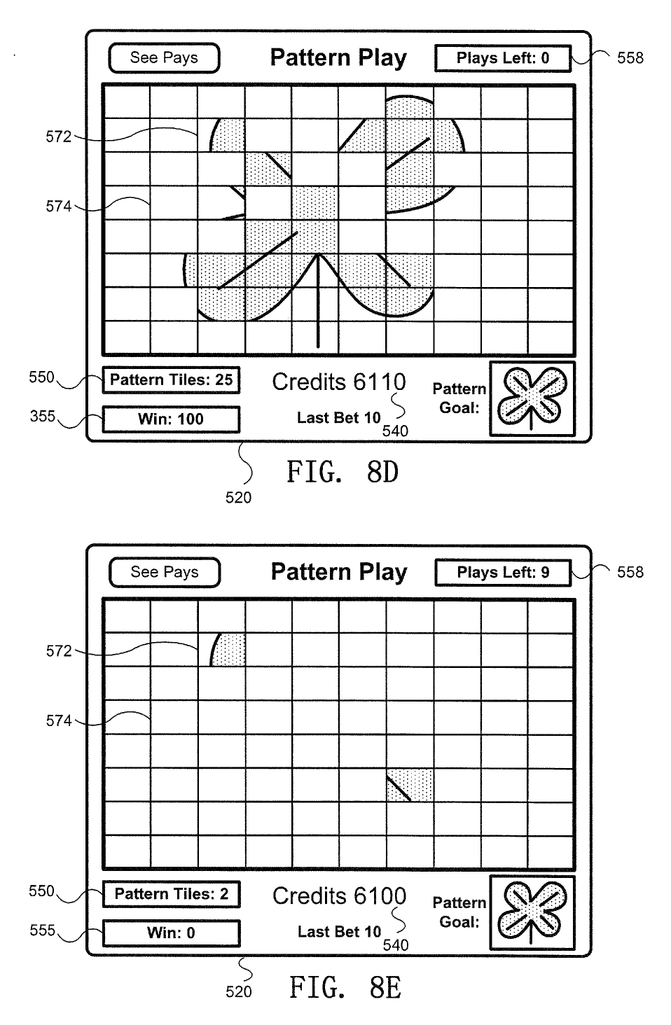

FIGS. 8A, 8B, 8C, 8D, and 8E are detail diagrams showing another example progression of game play on a pattern display of a gaming device according to embodiments of the invention. In this second game play progression, the various numbers of tiles of the pattern randomly are added to an image with each game play, where the goal again is to get as many pattern tiles (tiles with a portion of the selected pattern on them) as possible. Here, the player must complete as many of the pattern tiles as possible within a pattern-game series. A pattern-game series is a set number of games that is associated with a particular pattern. In this embodiment, the player has 10 games to get as many patterned tiles as possible. During each of these games, the player receives a random number of activated tiles. Random tiles on the pattern display are then activated, which may include pattern tiles or blank tiles outside of the pattern image areas. A paytable may include various prizes for a certain number of pattern tiles, such as illustrated in Table 2.

TABLE 2

| Number of Pattern Tiles | Award |
|---|---|
| 0-22 | 0 |
| 23 | 5 |
| 24 | 25 |
| 25 | 100 |
| 26-29 | 400 |
| 30-34 | 1000 |
| 35-39 | 5000 |
| 40-44 | 10,000 |
| 45 | 100,000 |

Referring to FIG. 8A, a gaming device 500 has a gaming cabinet 510 that includes a display 520 and a player interface panel 530 that includes one or more game buttons 532 and one or more game initiation buttons 533. The display 520 includes a pattern display 570, a credit meter 540, a pattern tile meter 550, a win meter 555, and a pattern goal image 565. In addition, the display includes one or more soft buttons that can be used to change game conditions or affect game play, and a series meter 558 that shows the number of games left in a pattern-game series.

The pattern display 570 is a matrix style board that includes 80 game tiles. When activated, some of these game tiles are pattern tiles 572 that include a portion of goal pattern, while other tiles 574 do not include any portion of the pattern. Non-activated tiles can appear in areas where the pattern should be, but do not show the associated pattern image and are not counted as pattern tiles. The pattern tile meter 550 shows the current number of pattern tiles 572 that are activated and show a portion of the goal pattern.

In this embodiment, the game tiles are randomly activated during each game play and accumulate during a pattern-game series. To illustrate this, FIG. 8A begins in the middle of a pattern-game series where a player has 6000 credits and 4 games remaining in a pattern-game series. During this game play the player has received a number of activated pattern tiles 572 that brings the total to 17 as shown on the pattern tile meter 550. Since 17 tiles are not associated with any win, the player simply loses the 10 credits that were wagered on the gaming event as shown in the credit meter 540. The series meter 558 is also decremented to show that the player has only 3 games left to play in order to win an award.

In FIG. 8B, the player again wagers 10 credits. This time the player receives a number of activated tiles including 3 new pattern tiles 472, which brings the total number of pattern tiles to 20 as shown on the pattern tile meter 550. Again, 20 pattern tiles do not correspond to a win and the credit meter drops down to 5980. The series meter 558 is also decremented to show that only two games in the pattern-game series remain.

The player again wagers 10 credits in FIG. 8C. Two more pattern tiles are revealed, although the total number of 22 is still not enough to get into the award category. However, one of the activated tiles 576 that is not in the pattern image area is revealed to have 50 bonus credits associated with it. This 50 credit win is reflected in the win meter 555, and the credit meter 540 is updated to shown the total number of available credits. The series meter 558 is also decremented to show that only one game in the pattern-game series remains.

In FIG. 8D, the last game in the pattern-game series is played. The player receives three pattern tiles 472, which is enough to push the player into the award portion of the paytable shown in Table 2. Here, the 25 total pattern tiles correspond to an award of 100 credits. These credits are added to the credit meter 540.

In FIG. 8E, the pattern is reset and a new pattern-game series is initiated. An initial game is played where the player receives two pattern tiles 572. As the series meter indicates, the player has nine more games to break into the prize portion of the paytable.

Embodiments that use this style of progressive pattern building utilize game series so that a player can build on game patterns over time. Because early games in the series do not have much chance of breaking into the award portion of the paytable, they may not be as exciting to players. However, large numbers of revealed pattern tiles means the player is getting close to the award portion of the paytable and the chance to win bonus prizes in activated tiles work to keep the player entertained and excited about the game.

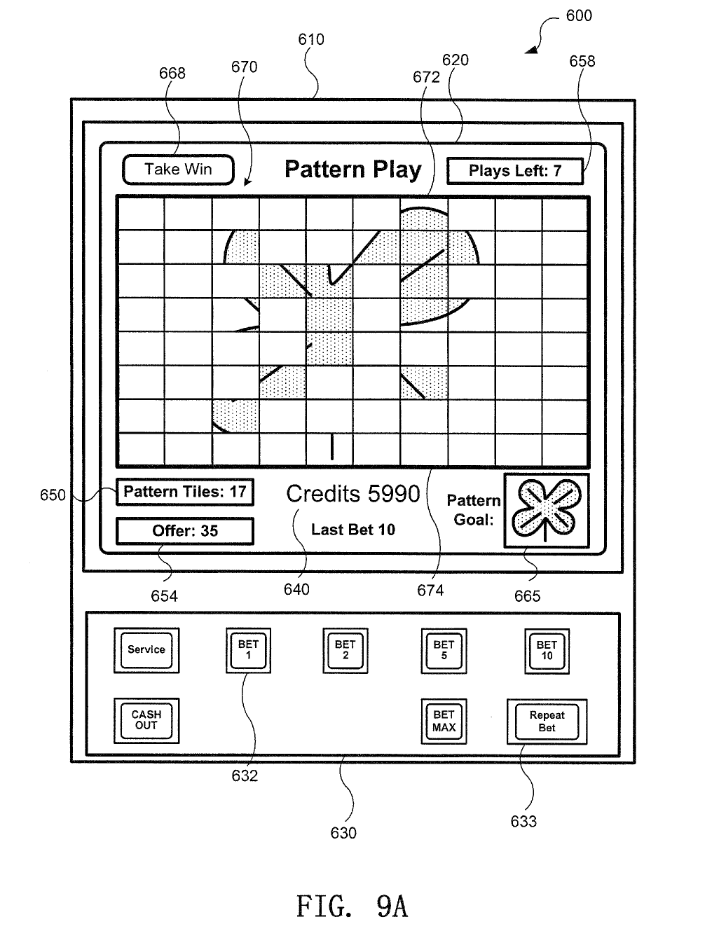

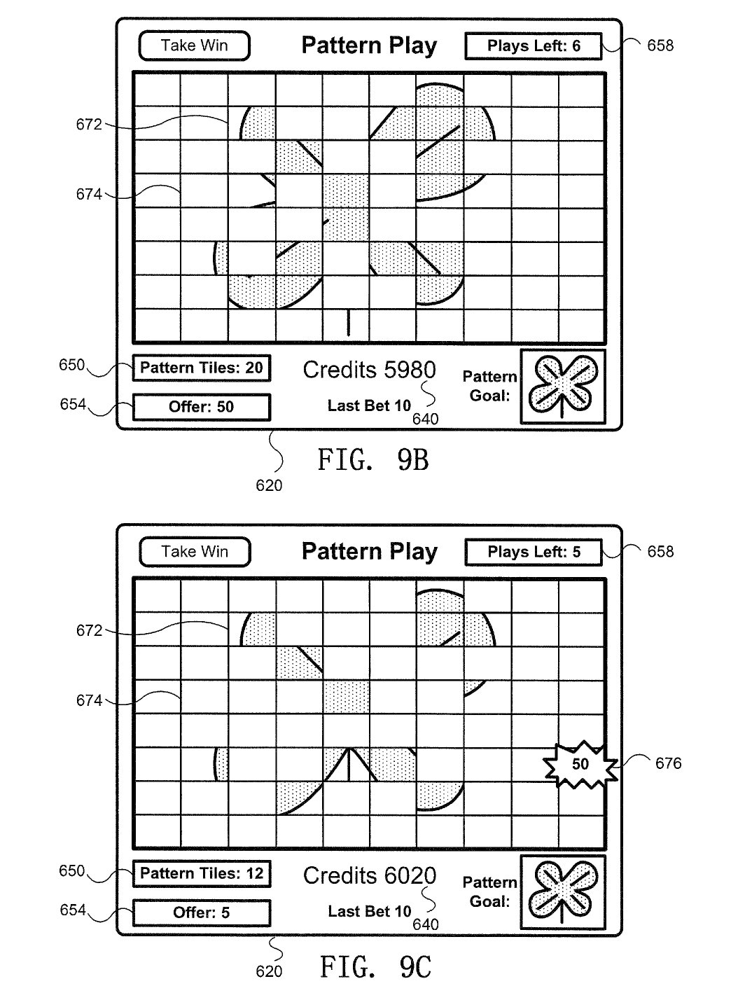

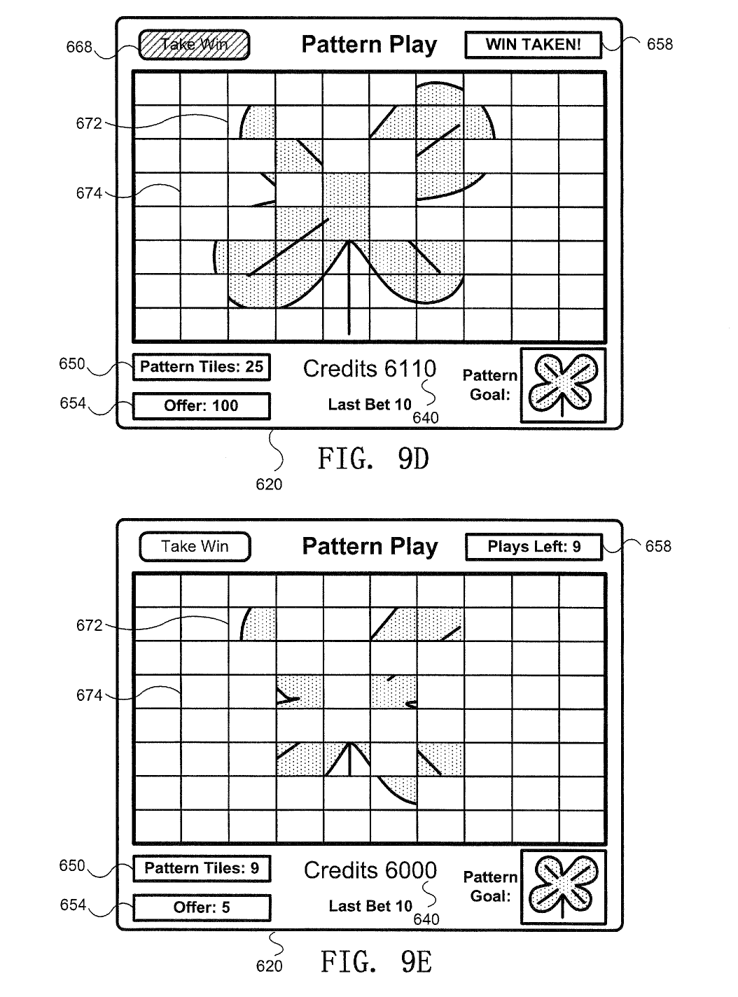

FIGS. 9A, 9B, 9C, 9D, and 9E are detail diagrams showing yet another example progression of game play on a pattern display of a gaming device according to embodiments of the invention. In this third game play progression, the various numbers of tiles of the pattern randomly are added to or removed from an image with each game play, where the goal again is to get as many pattern tiles (tiles with a portion of the selected pattern on them) as possible. Here, the player is playing within the confines of pattern-game series and must decide at various points whether to redeem an offered prize or risk it by continuing play. Since the tiles can be added, removed, or changed at random, there is no guarantee that the next offer will be as good as a first offer. Thus, the player must choose to risk known prize offers, if any, during a pattern-game series if they want to continue with a current pattern-game series. During each of these games, the player receives a random number of activated tiles. Random tiles on the pattern display are then activated, which may include pattern tiles or blank tiles outside of the pattern image areas. A paytable may include various prizes for a certain number of pattern tiles, such as illustrated in Table 3.

TABLE 3

| Number of Pattern Tiles | Award |
|---|---|
| 0-15 | 5 |
| 16 | 10 |
| 17 | 35 |
| 18-20 | 50 |
| 21-25 | 100 |
| 26-34 | 500 |
| 35-39 | 5000 |
| 40-44 | 10,000 |
| 45 | 100,000 |

Referring to FIG. 9A, a gaming device 600 has a gaming cabinet 610 that includes a display 620 and a player interface panel 630 that includes one or more game buttons 632 and one or more game initiation buttons 633. The display 620 includes a pattern display 670, a credit meter 640, a pattern tile meter 650, an offer meter 654, and a pattern goal image 665. In addition, the display includes one or more soft buttons that can be used to change game conditions or affect game play, such as a take win button 668, and includes a series meter 658 that shows the number of games left in a pattern-game series.

The pattern display 670 is a matrix style board that includes 80 game tiles. When activated, some of these game tiles are pattern tiles 672 that include a portion of goal pattern, while other tiles 674 do not include any portion of the pattern. Non-activated tiles can appear in areas where the pattern should be, but do not show the associated pattern image and are not counted as pattern tiles. The pattern tile meter 650 shows the current number of pattern tiles 672 that are activated and show a portion of the goal pattern.

In this embodiment, the game tiles are randomly activated during each game play, and an offer is made to the player corresponding to the number of activated pattern tiles 672. The player may redeem this offered award or continue play as long as there are games left in the pattern-game series. To illustrate this, FIG. 9A begins in the middle of a pattern-game series where a player has 6000 credits and 7 games remaining in a pattern-game series. During this game play the player has received a number of activated pattern tiles 572 that brings the total to 17 as shown on the pattern tile meter 650. The 17 pattern tiles received in this game corresponds to an offer of 35 credits as shown in Table 3. The player is this instance chooses to continue game play in this pattern-game series in hopes of receiving a better award offer. This decision may be influenced by the games remaining on the series meter 658, which shows that the player has seven more games left in which a better award may be offered.

In FIG. 9B, the player again wagers 10 credits. This time the player randomly receives 20 pattern tiles 672 and a corresponding award offer of 50 credits, as shown on the offer meter 655. The series meter 658 is decremented to show that the player has six games remaining. The player, however, again chooses to not redeem the offered credits shown on the offer meter 655.

The player again wagers 10 credits in FIG. 9C. Twelve pattern tiles 672 are activated during this gaming event, and the player is presented with an offer of five credits as shown on the offer meter 655. However, one of the non-patterned tiles 676 that is activated outside of the pattern image reveals a 50 credit bonus. This bonus is automatically added to the player's credit meter 640 without being part of the award offer for the gaming event. In other embodiments, any revealed bonus awards are added to the offer from the activated pattern tiles and become part of the offer on the offer meter 655 that the player may accept. Hence, in these embodiments, any revealed bonus awards are only won if the player redeems the offered credits.

In FIG. 9D, the player again wages 10 credits on a gaming event. Here, the player receives 25 activated pattern tiles 672 and receives an offer of 100 credits. This time the player presses the take win button 668. The series meter 658 indicates that the offer has been taken and the 100 offered credits are added to the credit meter 640. As the offer is taken, the current pattern-game series ends.

In FIG. 9E, the player has wagered 10 more credits on a new gaming event that marks the beginning of a new pattern-game series. The number of games in a pattern-game series may be predefined by a game designer or casino operator. In some embodiments, the number of games in a pattern-game series may be influenced by gaming conditions (e.g., time of day, day of the week, etc.) or by player characteristics (e.g., identified player, player level, coin-in, time of play, etc.). For example, an identified player playing mid-week may receive 15 games per pattern-game series, while a non-identified player playing during the weekend may only receive 5 games per pattern-game series. Although the number of games per pattern-game series does not directly affect the maximum size of a possible award, it does give a player more opportunities to have larger offers before being forced to take an offered award at the end of the pattern-game series. As shown in Table 3, the player will always have some credit offer with each turn. This ensures that the player will win at least some credits at the end of a pattern-game series. However, in other embodiments, a paytable may only offer credits for certain numbers of activated pattern tiles 672. In these embodiments, the gaming device may be configured to ensure that the player has some offer on the last game of a pattern-game series. In addition, various paytables may be used to increase the chance of large offers later in a pattern-game series. For example, a player may have only a small chance of getting an offer in the first few games of a series, but have a very good chance of receiving an offer in the later games of the series. In yet other embodiments, the number of games in a pattern-game series is randomly selected prior to the start of each pattern-game series.

In this instance, the player has received ten games in the pattern-game series. The first game in this series has resulted in nine pattern tiles 672 being activated, with a corresponding offer of five credits.

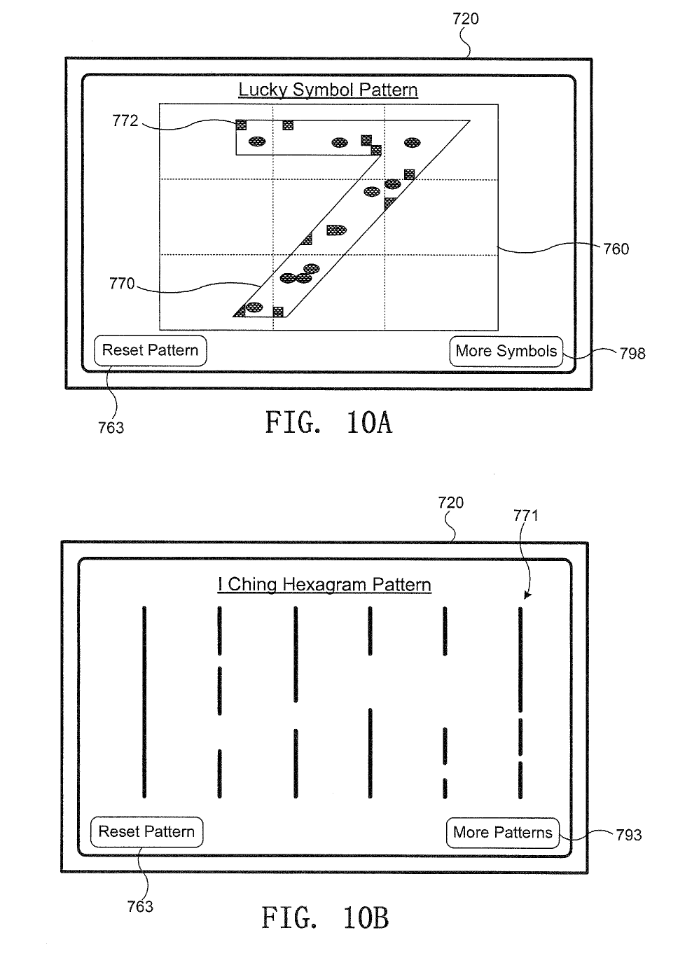

FIGS. 10A and 10B are detail diagrams of pattern displays showing different types of patterns associated with game play on a gaming device according to embodiments of the invention.

Referring to FIGS. 10A and 10B, pattern displays 720 are shown with different pattern formats. As discussed above, various styles of pattern data may be presented to a player, which may be dictated by the type of gaming device, the type of pattern requested, and/or the preferences of a particular player. The pattern displays 720 are shown as individual displays, but they may take any of the forms of the pattern displays discussed above.

Referring to FIG. 10A, the pattern display 720 includes symbol 770 overlaying a grid 760. The goal in this embodiment may be fill in a chosen symbol 770 with shading or coloration. The player may choose (or be assigned) a symbol associated with good luck. The symbol may be presented in an outlined form (as illustrated) to be filled in. However, in other embodiments, the symbol may not include an outline such that it begins transparent and is filled in as the pattern develops (such as shown in FIG. 5). Alternatively, the symbol 770 may initially include some shading or coloration that is replaced or modified as the pattern develops. The grid 760 may correspond to visible symbol positions on a game display of a slot machine. The grid 760 may also correspond to a poker hand (i.e., five sections in the grid), or other gaming device display. Here, the grid 760 corresponds to a three reel slot machine (three vertical columns, each with 3 visible symbol stops). The grid 760 may be used with the symbol 770 to generate a symbol-based pattern.

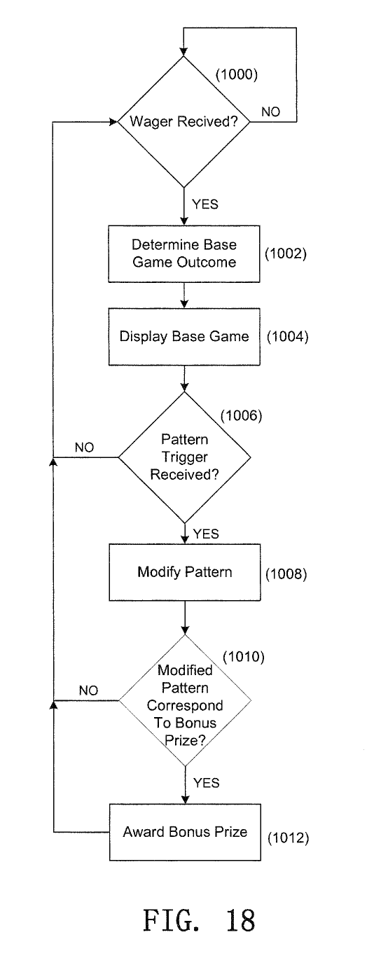

In embodiments where the pattern display 720 is a part of a bonus game, or is included in addition to a gaming display, as discussed below with respect to FIG. 17), the grid 760 may be utilized by recognizing particular reel symbols (such as a jackpot or bonus symbol) received on the gaming display and filling in a portion of the symbol 770 that corresponds to the grid section associated with the reel stop position containing the particular reel symbol. For example, if a jackpot symbol was received in the upper position of the third reel, a portion of the symbol 770 in the grid section associated with the reel stop position may be shaded or colored. Likewise, if a jackpot symbol was received in the middle position of the third reel, a portion of the symbol 770 in the corresponding grid section would be shaded. However, since no part of the symbol 770 falls within grid section at the bottom right position, a jackpot symbol landing on the bottom position of the third reel may not modify the pattern display 720.

The type or shape of shading or coloration used to fill in the symbol 770 may be based on a reel symbol received on the game display, may be chosen at random, or may correspond to the portion of the symbol 770 that is selected to be colored/shaded. For example, different shapes of shaded areas 772, such as a shaded box, a shaded oval, and a shaded triangle may be alternately used, randomly chosen, or assigned to a symbol portion based on the location of the symbol portion. Alternately each of the shading shapes 772 may represent a respective type of outcome received (e.g., the shaded box is used when a jackpot symbol is received, the shaded oval is used when a bonus symbol is received, and the shaded triangle is used when a doubling symbol is received). More or less shading shapes 772 may be used depending upon the desired effects. In additional embodiments, blanks or other symbols received on the reel strips may remove a portion of the shading 772 in a corresponding grid section.

In other embodiments where the pattern display 720 is the base game of a gaming device, the grid 760 and the associated functionality may be omitted. In those embodiments, the symbol 770 may just be randomly filled in, or types of shaded portions 772 may be selected by the player and appear on the symbol. As discussed above, the player may also be able to shift, move, or otherwise modify the shaded portions 772 in the symbol 770 during game play. Awards here, may be based on the percentage of the symbol that is filled in, or based on other game-determinative criteria.

In some embodiments, both areas of the symbol 770 and areas outside the symbol on the pattern display 720 may be shaded. In these embodiments, it may be preferable to assign lighter colors or shades to the background and assign darker colors or shades to the symbol (or the reverse) to contrast and emphasize the symbol. During game play in these embodiments, various areas of the pattern display 720 may become shaded, but the player may only be moving closer to an award when the shaded areas 772 within the symbol reach a predefined threshold.

One or more player interface devices (e.g., 763 and 798) may also be associated with the pattern display 720. In this embodiment, the pattern display 720 includes a Reset Pattern button 763 and a More Patterns button 798. The Reset Pattern button 763 may reset the pattern shown on the pattern display 720, as discussed above. For example, the Reset Pattern button 763 may completely clear the shaded portions 772 of the symbol 770 or may display a new random pattern of shaded portions 772 within the symbol 770 or pattern display 720.

The More Symbols button 798 may be present to assist the player in selecting a symbol to use with the pattern display 720. This button 798 may only be available to certain players or may only be available at certain times. If a player is an identified player, the player may be able to upload a desired symbol at a kiosk or over a wireless or Internet connection to their player account. The player may then be able to use the More Symbols button 798 in conjunction with a player identifying device 45 (FIG. 1) to access the uploaded symbol. The More Symbols button 798 may also be used to change the pattern type or perform any of the functionality of the More Patterns button 793 (FIG. 10B) discussed below.

The pattern display 720 shown in the embodiment illustrated in FIG. 10B is an I Ching Hexagram pattern display including six line portions 771 having a plurality of dash segments associated with each line. Hexagram patterns typically consist of various dashed lines arranged in six line shapes that correspond to particular meanings derived from an ancient Chinese text. As the line shapes or portions 771 receive additional dashed segments and/or have dashed segments removed, certain hexagram meanings may become apparent. Although a hexagram pattern is shown in this embodiment, trigrams or any other symbol based patterns may be utilized in the pattern display 720. The dashed segments added or removed may be relatively small so that the hexagram pattern is slowly modified over time. Particular rules may be set up to further associate the patterns with identifiable symbols. For example, a rule may be instituted that no more than three separate line segments may be present in any one line portion 771, even though the dashed segments that are added or removed may be much smaller than any of the separated segments (i.e., the additions or subtractions would typically take place at the end of one of the line segments if three line segments were present in a line portion 771).

Again, one or more player interface devices (e.g., 763 and 793) may also be associated with the pattern display 720. In this embodiment, the pattern display 720 includes a Reset Pattern button 763 and a More Patterns button 793. The Reset Pattern button 763 may reset the pattern shown on the pattern display 720, as discussed above. For example, the Reset Pattern button 763 may completely clear the lines 771 of the hexagram, may display only solid completed lines 771, or may display a random pattern of dashes within the lines 771.

The More Patterns button 793 may allow a player to change the type of pattern that is displayed (e.g., change the hexagram pattern shown to a symbol reveal pattern) or to alter various parameters the pattern display (e.g., the color of the lines 771). That is, by pressing the More Pattern button 793, a player may change the format of the pattern data displayed on the pattern display 720. The More Pattern button 793 may also be used by the player to save, print, or otherwise memorialize the displayed pattern. For example, if a player wants to save a pattern displayed on a gaming device, the player may use the More Patterns button 793 to access a menu that lets the player save the data to a player loyalty account (if they are a member of player loyalty club), or print the data on a ticket printer (FIG. 1) attached to the gaming device, or another printer that may be attached to the gaming device or remote from the gaming device. The player may even be able to email or text the pattern to a home computer or wireless device.

FIG. 11 is a flow diagram showing a method of operating a gaming device having a pattern display according to embodiments of the invention.

Referring to FIG. 11, the gaming device operation method includes displaying a first pattern on a pattern or game display (800), receiving a pattern modification signal (802), and modifying the first pattern to create a second pattern on the pattern or game display (804). The method then determines if the second pattern corresponds to an award (806). If the pattern does correspond to an award, the award associated with the second pattern is presented to the player at the gaming device (808). Alternatively, if the pattern does not correspond to an award, the method returns to process (800) and the second pattern is displayed on the pattern or game display while waiting for further game play from the player.

Depending on the embodiment, process (800) may include displaying the current pattern on a main game display (or pattern display) for use in a base game as discussed above with respect to FIGS. 4-9E, or may include displaying the current pattern on a secondary pattern display separate from a main gaming display as discussed below with respect to FIG. 17. The pattern modification signal in process (802) may be received in response to player placing a wager and initiating a game for embodiments where the pattern play is the base game, or may be received in response to an outcome on a base game in embodiments where the pattern play is a secondary or bonus game. The pattern may be modified in process (804) in any of the various ways discussed in this disclosure, or in any other way that falls within the scope of this inventive concept.

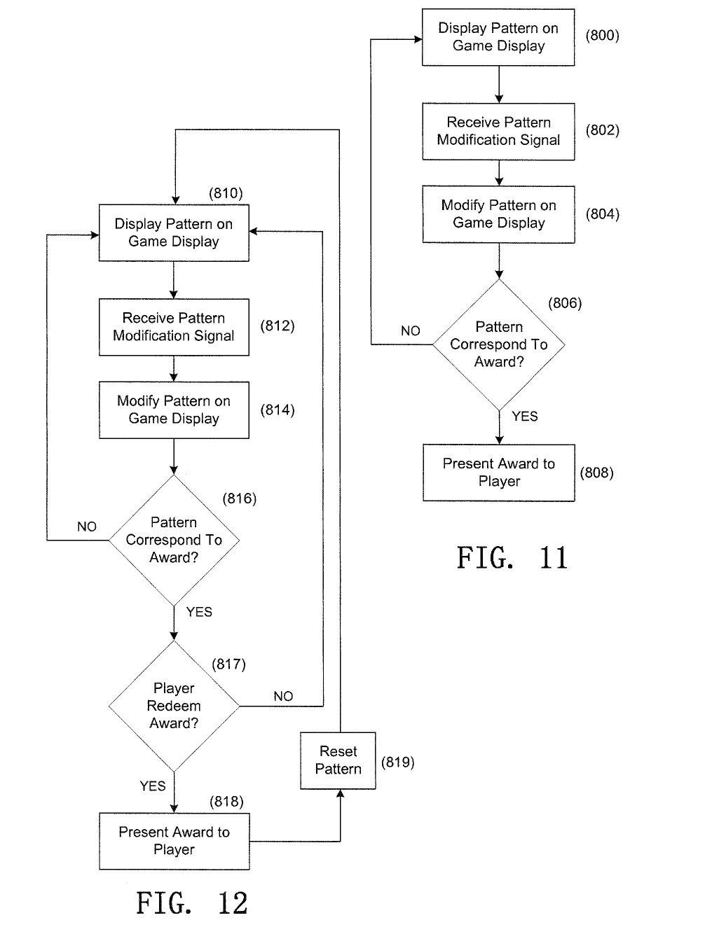

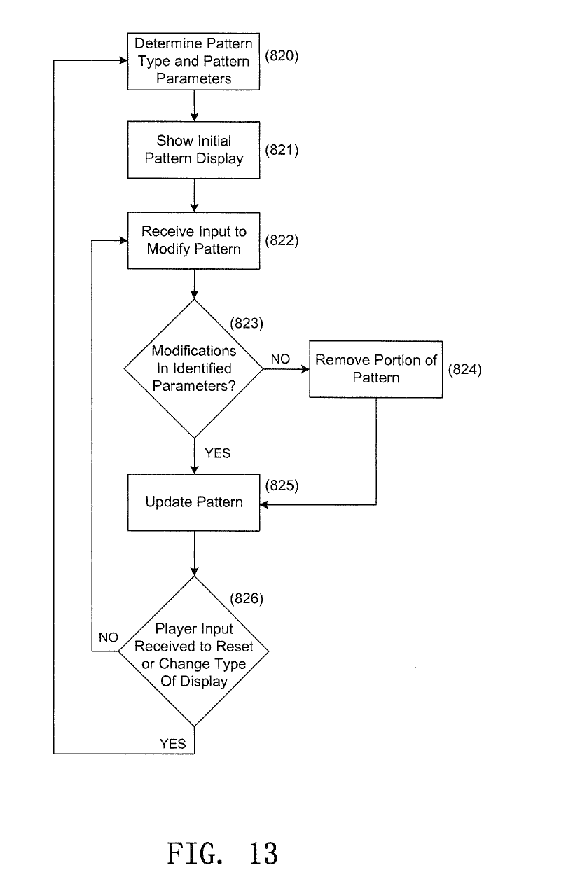

FIG. 12 is a flow diagram showing another method of operating a gaming device having a pattern display according to embodiments of the invention. The method embodiment shown in FIG. 12 differs from the previous method embodiment shown in FIG. 11 by determining if an award available to a player is redeemed.

Referring to FIG. 12, the gaming device operation method includes displaying a first pattern on a pattern or game display (810), receiving a pattern modification signal (812), and modifying the first pattern to create a second pattern on the pattern or game display (814). The method then determines if the second pattern corresponds to an award (816). If the pattern does not correspond to an award, the method returns to process (800) and the second pattern is displayed on the pattern or game display while waiting for further game play from the player. If, however, the pattern does correspond to an award, the method proceeds to process (817) where it is determined if the award is redeemed. If the award is not redeemed, the method again returns to process (810) and the second pattern is displayed on the pattern or game display while waiting for further game play from the player. If, on the other hand, the award is redeemed, the award associated with the second pattern is presented to the player at the gaming device (818). After, the award is presented to the player, the pattern is then reset (819) and the method returns to process (810) to display the new pattern and await further game play.

Depending on the embodiment, process (817) may show the corresponding award to the player and offer the player the choice to redeem the award or continue game play. Alternatively, the decision to redeem the award may be at least in part controlled by the gaming device, where, for example, the player is at the last play in a game series and must redeem the corresponding award.

FIG. 13 is a flow diagram showing methods of updating a pattern display according to embodiments of the invention.

Referring to FIG. 13, a method of adjusting or refreshing a pattern in a pattern display includes determining a pattern type and parameters of the pattern to be displayed (820). For example, random pattern in a 50 by 10 grid may be requested. After the parameters are determined, an initial pattern conforming to the determined parameters may be displayed (821). In the example above (the random 50 by 10 grid pattern), the initial pattern may simply be blank grid with no shading or coloration, or an initial algorithm may be run to randomly shade, color, or fill-in portions of the pattern display in creating an initial pattern.

After an input is received to modify the pattern (822), the gaming device or gaming system may determine if the modification is within the identified parameters associated with the pattern (823). In the above example, if the pattern parameters specify that only 200 of the 500 spaces in the random pattern grid may be shaded, colored, or filled in at any one time and the pattern currently has 200 shaded spaces, a portion of the pattern may be removed (824) before the specified modification is carried out (825). If on the other hand, only three spaces are currently shaded, the modification would fit in the 200 shaded-space parameter, and the pattern would simply be updated with the modification (825). The modification of the pattern may be randomly chosen (e.g., a space may be chosen at random to be updated with a random color or shade) or may be based in least in part on the type of modification input received.

The gaming device or gaming system then determines if a player input has been received to reset or change the pattern display (826). When no player input is received, the game simply waits until the next input is received to modify the pattern (822). However, when a player directs the gaming device or gaming system to change the display of the pattern, the entire process may be repeated starting with the determination of the pattern type and parameters associated with the pattern (820). In the first discussed example, if the player decides he or she wants to see an I Ching Hexagram instead of the random pattern grid, the pattern type and pattern parameters may be re-determined (820) and a new pattern may be displayed according to the new parameters chosen or associated with the display.

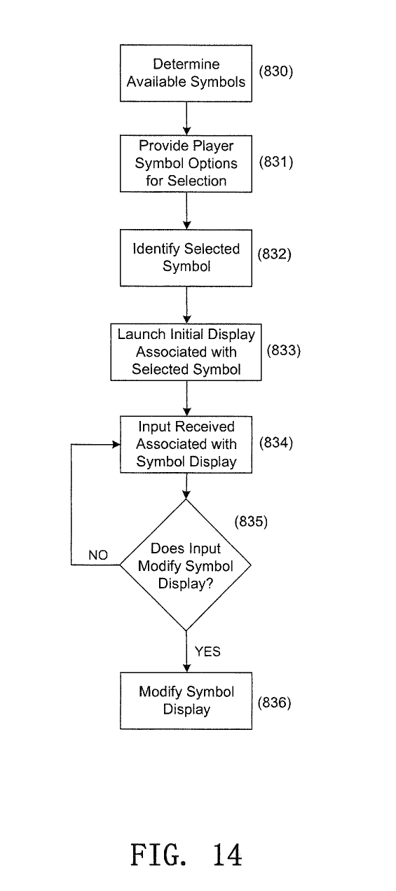

FIG. 14 is a flow diagram illustrating methods of displaying a pattern display according to embodiments of the invention.

Referring to FIG. 14, the method of displaying a pattern display is used to complete a selected symbol, such as is illustrated in FIG. 5. The method includes determining symbols that are available for selection (830). A list or menu of symbols may be kept on the gaming device or a connected server for use on a pattern display associated with the gaming device. Additionally, a player may be able to import or otherwise upload a symbol to use for the pattern display. The player is then provided with the symbol options for selection (831). Here, the player is presented with the list or menu of possible symbols to use. The player may choose a symbol that they feel is lucky, or one they identify with. In other embodiments, the symbol may be chosen at random by the gaming device or server. The selected symbol is then identified (832) and an initial display is launched with the selected symbol (833). As discussed above, the initial display may include no shading/coloration or may have random portions of it shaded or colored.

The gaming device then waits for an input to be received that is associated with the symbol display (834). After such an input is received, the gaming device determines if the received input modifies the symbol display (835). Referring to FIG. 5, an input may be received that is associated with a portion of the pattern display 270 that is not covered by the symbol 272. In that instance, the symbol display would not be modified even though an input associated with the display is received. As discussed above, the input may be random or may be triggered by a gaming event or player input. Referring again to FIG. 14, if the gaming device does determine that the received input is associated with a symbol modification, the symbol display is modified (836). Although a portion of a symbol may be designated as having a modification, the exact position of the modification and/or the type of modification may be determined at random.

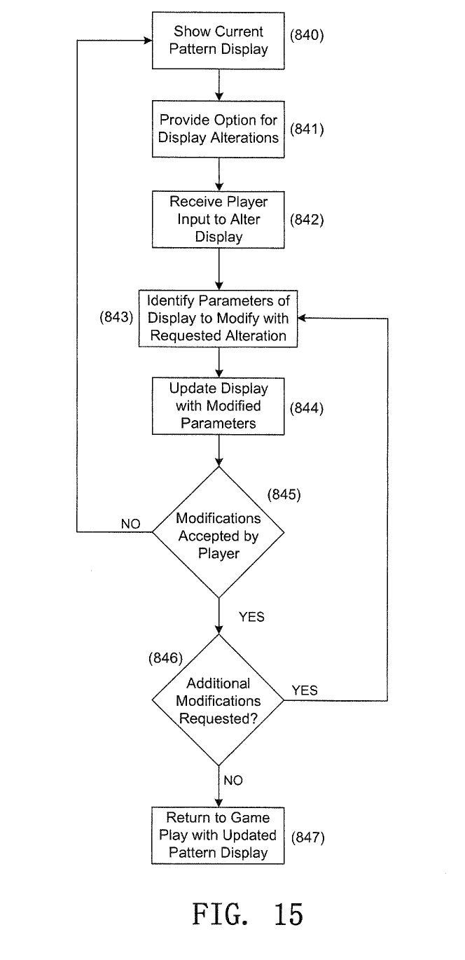

FIG. 15 is a flow diagram illustrating methods of altering a pattern display according to embodiments of the invention.

Referring to FIG. 15, a method of altering a pattern display includes showing a current pattern display (840) along with providing options for altering the display (841). These options may always be available, or may only be periodically available to a player. For example, the options for altering the display (841) may only be available to identified players, be available while a gaming event is not taking place, or be available after a predetermined number of gaming events have been completed. After the alteration options are provided, the gaming device receives a player input to alter the pattern display (842). The parameters of the pattern display are identified so that appropriate ones of the parameters can be properly altered by the requested modification (843). These parameters may include a pattern display type, boundary conditions of the pattern display, shading/coloration schemes currently being used, zooming in on a portion of the pattern, rotating the pattern, etc.

The parameters previously identified are modified as needed to generate an updated pattern display (844). The gaming device may then inquire if the modifications are acceptable to the player. If they are not acceptable, the gaming device may revert back to displaying the current pattern display (840) and restart the process if desired by the player. Alternatively, if the modifications are accepted by the player, the gaming device may inquire if any further modifications are requested (846). If the player wants to make additional modifications to the pattern display, the gaming device may again identify the parameters of the display that are to be modified in response to the modification request (843). If the player is satisfied with the modifications, the gaming device may return to game play with the updated pattern display (847).

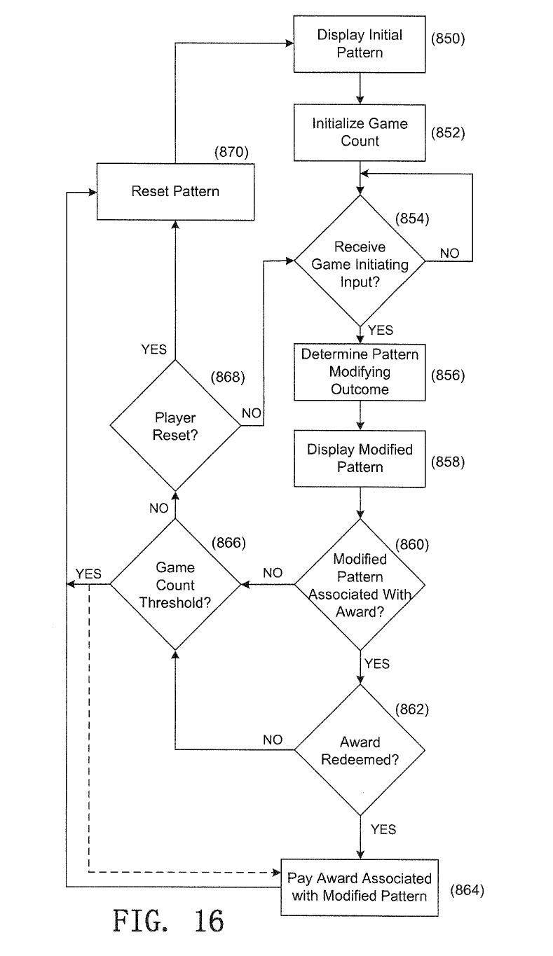

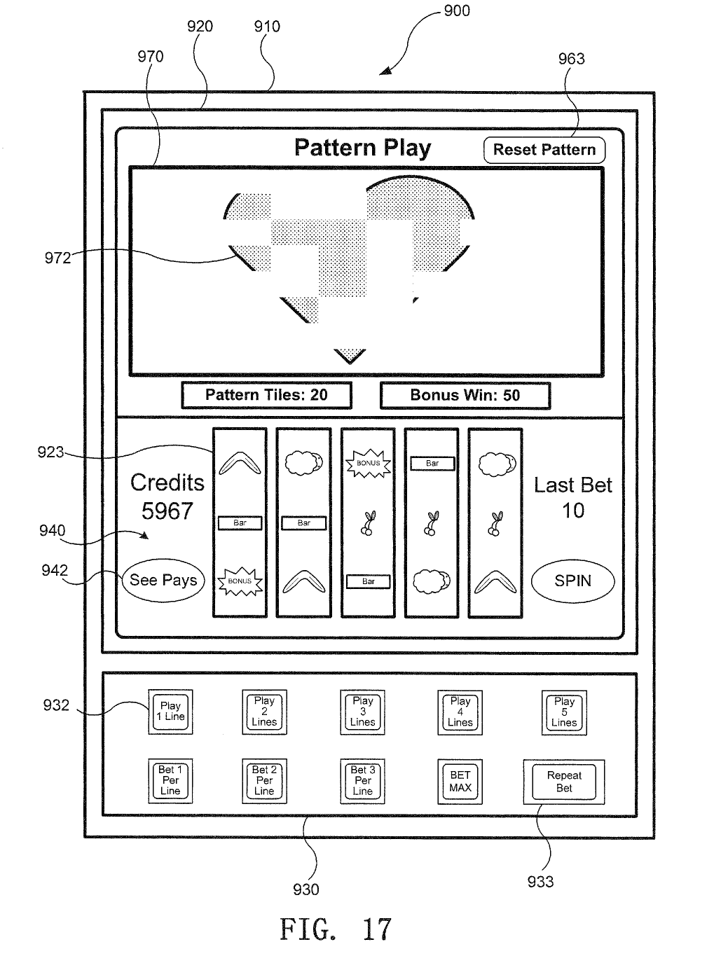

FIG. 16 is a flow diagram showing another method of operating a gaming device having a pattern display according to embodiments of the invention. In particular, this illustrated method shows embodiments of game play that use a game-pattern series style of game play. As discussed above, a game-pattern series may include game play that is configured to span two or more games or gaming events that are wagered on by the player with a common pattern goal. That is, the player may reset a pattern or redeem an award after a first game event to end a game-pattern series, but there is the option to continue beyond the first game event to further modify the same pattern if the player so desires.

Referring to FIG. 16, the gaming device operation method starts the game pattern series by displaying a first pattern on a pattern or game display (850), initializing a game count (852), and determining if a game initiating input has been received (854). If a game initiating input has been received, the method proceeds to process (856) to determine a pattern modifying outcome, and then to process (858) where the pattern that is modified by the pattern modifying outcome is displayed. The method then determines if the modified pattern corresponds to an award (860).

If the pattern does correspond to an award, the method proceeds to process (862) where it is determined if the award is redeemed. If the award is redeemed, then the award associated with the modified pattern is paid to the player (864) and the current game-pattern series ends. After the award is paid, the pattern is reset (870), and a new game-pattern series begins where an initial pattern is displayed in process (850).

Returning to process (860), if the pattern does not correspond to an award, or if the award is not redeemed in process (862), the method continues to process (866) where it is determined if a game count threshold has been reached. If the game count threshold has been reached, the current game-pattern series ends and the pattern is reset in process (870). In some embodiments, any pay that is associated with a modified pattern when the game threshold has been reached is paid out to the player (864). If the game count threshold has not been reached, the method proceeds to process (868), where it is determined if the play has chosen to reset the pattern. This may occur when, for example, the player presses a “Reset Pattern” button on the player interface panel or game display (e.g., button 363 in FIG. 6). If the player has not reset the pattern, the method returns to process (854), where the gaming device waits for a game initiating input to be received to continue the game-pattern series. If the player has reset the pattern as determined in process (868), the method proceeds to process (870) where the pattern is reset.

FIG. 17 is a detail diagram of a gaming device 900 having a bonus pattern display 970 according to embodiments of the invention.

Referring to FIG. 17, a gaming device 900 having a gaming cabinet 910 includes a display 920 and a player interface panel 930. The player interface panel 930 includes one or more game buttons 932 to provide game play functionality or options, and includes one or more game initiating buttons 933 to initiate gaming events on the gaming device 900. The display 920 includes a gaming display 940 showing a base game, and includes a pattern display 970 showing a pattern that is a secondary or bonus game on the gaming device 900.

The use of a more familiar “base” game can be used in several ways depending on the embodiment of this concept being implemented. In one embodiment, game reels 923 are spun on the game display 940 to dictate what pattern elements or tiles 972 are revealed on the pattern display 970. Here, the number of pattern elements 972 that reveal part of the pattern may still be used as the sole determination of whether a player is awarded a prize. That is game play is still centered on what portion of the pattern is revealed in a manner similar to the embodiments discussed above with respect to FIGS. 4-9E, but instead of pattern elements 972 being randomly revealed or manipulated, they are revealed or manipulated based on the random outcome of the base game shown on the game display 940. For example, if three bar symbols appeared on a payline in the base game shown on the game display 940, two pattern elements 972 may be revealed on the pattern display 970.

In other embodiments, the pattern on the pattern display 970 may be used in conjunction with the base game on the gaming display 940 to provide wins for the player. That is, the base game using the spinning game reels 923 may have awards associated with outcomes that appear on the game reels. The pattern elements or tiles 972 on the pattern display 970 may be influenced by this base game outcome, or a separate random game outcome, and may be analyzed for wins along with the base game. That is, in these embodiments, the player may receive awards from the base game and/or from the pattern-based game with each wager.

The gaming display 940 shows the results of a base game event played by a player on the gaming device 900 using game buttons 932 and/or a game initiation input device 933. The pattern display 970 is configured to show portions of a goal image that is to be completed as a secondary pattern game. As it is completed, the pattern tiles 972 show greater portions of the goal image which become recognizable to the player as the pattern progresses. The type of goal image, or stage of completeness may influence the player to play or not to play the gaming device 900, or to change their wager size, change their betting style, or otherwise influence their behavior. For example, if a player wins a jackpot on a gaming device or has a particularly good string of wins with a particular pattern on a gaming device, they may note a pattern image shown on the pattern display 970 and associate the noted pattern with good luck. The player may than use a similar pattern with subsequent pattern-based games, or search out devices with a similar pattern in subsequent visits. Additionally, if a similar pattern completion or reveal progression becomes evident while the player is playing a gaming device, the player may increase their wager size or bet more frequently because they remember the win or wins they received previously when a similar pattern was displayed. In embodiments where the player can manipulate the pattern, the player may further attempt to manipulate the pattern so that it resembles the previously noted pattern progression.

The pattern display 970 may include a presentation of images or a collection of marks created at random or associated with an aspect of a game outcome. To facilitate pattern creation, the pattern display may include a plurality of addresses at which a mark can be assigned. In some embodiments, these marks are randomly assigned by a game RNG or secondary RNG included in the microprocessor 40 (FIG. 1) of the gaming device 900 to an address or other defined portion of the pattern display. These marks may include a random selection between a plurality of different mark types or mark colors, which may add variety or complexity to the pattern image created by the accumulation of marks or tiles 972. Additionally, if a portion of the pattern display 970 for which a new mark 972 is assigned already includes an existing mark, the new mark may replace the existing mark (i.e., the old mark is removed, and the new mark takes it place), or the existing mark may be modified by the new mark. For example, the existing mark 972 may become darker with the addition of the new mark, the color of the existing mark may be modified by the color of the new mark, the portion where the mark is shown may be divided or apportioned between the two marks, or other image blending techniques may be used to combine the parameters of the two marks. If a pattern display 970 has a threshold number of marks 972 that may be presented at any given time, the placement of a new mark may require the removal of another existing mark. The existing mark to be removed may be identified at random, or may be chosen using an algorithm or set of rules, such as the removal of the mark with the closest proximity to the new mark, removal of the oldest existing mark (FIFO—First In First Out), or removal according to another scheme. The pattern display 970 may be modified (i.e., marks 972 may be generated or modified) at periodic intervals, at random, in response to a game event, or in response to another pattern modification signal.

In other embodiments, patterns may be generated by randomly assigning a mark 972 within a predetermined boundary or range within the pattern display 970 in response to a game outcome or other game event. The predetermined boundary or range may include portions of player selected or otherwise predetermined symbol that is modified by the pattern markings. That is, a symbol or image may be presented in an outlined or other format on the pattern display with identified portions (or address) ranges corresponding to game outcomes. For example, portions of the symbol may be tied to sizes or categories of wins. Top portions of the symbol may be marked by base game outcomes of a certain category (e.g., three symbol combinations), center portions of the symbol may be marked by game outcomes of another type (e.g., four or five symbol combinations), and bottom portions of the symbol may be marked when other types of game outcomes are present (e.g., scatter symbols). In another example, specific portions of the symbol may be marked when game symbols, cards, or other indicia are received on certain portions of a game display 940. That is, particular reel symbols landing on a visible portion of the game reels 923 (reel position) may trigger a pattern modification signal to generate a mark within a range of addresses (or portion) of the pattern symbol corresponding to the reel position. Although specific addresses of the pattern display 970 may be associated with particular game outcomes, ranges of addresses may preferably be associated with the game outcomes where the specific address of the modification is chosen at random within the address range so that the element of randomness is maintained with the generation of the pattern image on the pattern display 970. In some embodiments, game outcomes may be assigned different weights that generate more or less marks 972. For example, large symbol combinations may trigger three marks to be generated and used to modify the pattern display 970, while smaller symbol combinations may generate only two or one mark 972 used to modify the pattern display.

The gaming device 900 shown in the embodiment illustrated in FIG. 4 is a video slot machine. While specifics relating to this particular type of gaming device are discussed below with reference to this embodiments, this inventive concept may be embodied in a wide variety of gaming device types, such as a mechanical spinning reel slot machine, a video poker machine, live-action or electronically controlled table games, internet gaming devices, wireless gaming devices, or other types of gaming devices.

The pattern display 970 shown in this embodiment is a heart completion pattern similar to that discussed above with respect to FIG. 4. However, various other types of patterns may be shown on the pattern display 970 according to game type, player preference, game/casino theme, etc.

To reset the pattern, a player may use the “Reset Pattern” button 963 on the display 920. Although this button 963 is shown as a soft button in this illustrated embodiment, the “Reset Pattern” button may be a physical input device or may be linked to one of the game buttons 932. The Reset Pattern button 963 may operate in a similar manner to the reset button discussed above with respect to FIG. 6.

The pattern on the pattern display 970 may also be manipulated or changed by a player in some embodiments. These operations may include manipulating an aspect of the current pattern or selecting a new type of pattern to show on the pattern display. These operations may be carried out by a player input on the pattern display 970 (e.g., touching the pattern display) or may have a separate player button (such as a “More Patterns” button as shown in FIG. 5) associated with the action.

Although the pattern display 970 is shown on the same display 920 as the gaming display 940, in other embodiments, the pattern display 970 may be shown on a separate display screen, such as a secondary display 25 (FIG. 1), a top box display, or a remote display separate from the gaming device 900. If the pattern display 970 is shown on the same display 920 as the gaming display 940, it may be shown substantially simultaneously with the game play display 923 (as shown in this embodiment illustrated in FIG. 17). In other embodiments, however, the pattern display 970 may be shown at periodic intervals with other game information, such as a banner or paytable, during game play. The player may also press a gaming button 932, soft button 942, or other player input device to bring up and/or manipulate the pattern display 970. During this request, the pattern display 970 may be displayed along with the gaming display 940, or may replace the gaming display. Additionally, when the game is not in play, the pattern display 970 may be used as part of an attract screen to draw players to the gaming device.

Pattern data used in the pattern display 970 may be maintained in the gaming device memory 41 (FIG. 1) or maintained in a remote database 90 (FIG. 3) connected to the gaming device via a network 50. Even when the pattern data is maintained in a remote database 90, the local gaming device memory 41 may be used to temporarily store recent modifications to the pattern data. This temporality stored data may be transferred to the remote database 90 periodically and/or in response to a triggering event, such as a player cashing out or otherwise ending a game session. Here, a remote server 80 (FIG. 3) and a game processor 40 (FIG. 1) may be used to coordinate and otherwise facilitate this transfer of the pattern data. The server 80 may include a receiver, such as an input port, to receive pattern data recorded and/or stored at the gaming device 900. The server 80 may also include a processor that processes the updated pattern data and generates the visual depiction of the updated pattern data that is to be displayed to the player. A transfer unit may further be included in the server 80 to transfer this visual depiction to the gaming device 900 so that an updated image of the pattern data can be shown on the pattern display 970.

In some embodiments, the ability to provide a pattern display 970 may be downloaded to a gaming device 900 from a remote server 80 (FIG. 3) if requested by a player and/or if the player meets predetermined criteria. That is, a pattern play module may be transferred to a gaming device 900 to provide the gaming device instructions or directives for displaying a pattern display 970 on at least one of the existing displays associated with the gaming device 900. Here, the pattern play module may direct the gaming device to maintain pattern data as well as process and display the pattern data. Alternatively, the pattern play module may direct the game device to periodically transfer recorded pattern data to the server 80 to be processed and returned in a graphical form for display to a player as discussed above. By utilizing pattern play modules, existing gaming devices could be modified to provide a pattern display 970 to players. Pattern play modules may also be an option for a server based gaming environment where players download games to game device terminals.

There are several advantages of maintaining pattern data records on a remote database 90. These advantages include the flexibility of processing pattern data for a particular player over multiple game devices, for particular types of game devices, or even gaming devices spread across related casino properties. Here, the remote pattern data can be accessed by any gaming device that is connected to the remote server 80 and utilized in preparing a pattern display for a player of the gaming device 900.

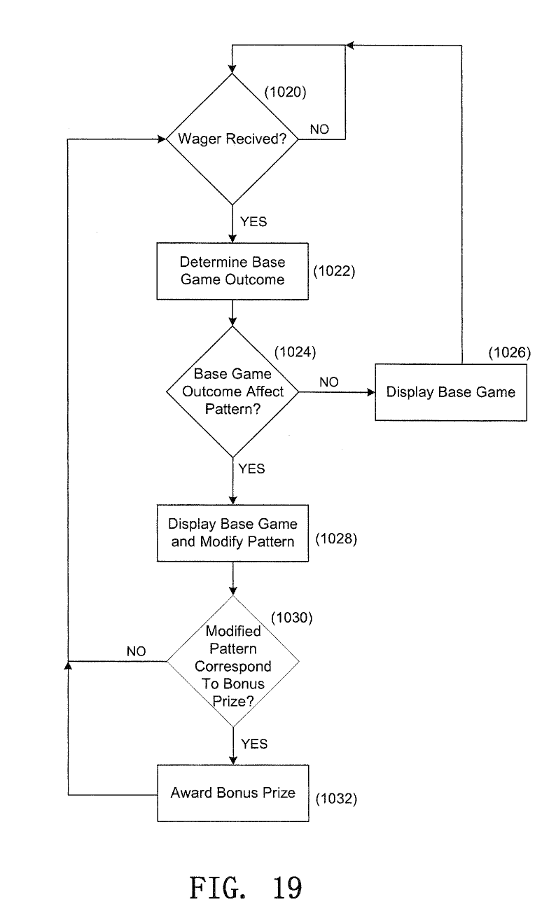

FIG. 18 is a flow diagram showing a method of operating a gaming device having a bonus pattern display according to embodiments of the invention. This illustrated game device operation method is directed to gaming device embodiments with a non-pattern base game and a pattern-based secondary game, such as the gaming device illustrated in FIG. 17. As discussed above, the base game may be any type of known game, such as a spinning reel game, a video poker game, etc.

Referring to FIG. 18, the gaming device operation method includes determining if a wager has been received in process (1000), and determining a base game outcome in process (1002) when a wager has been received. The determined base game outcome is displayed in process (1004) and it is then determined if a pattern trigger has been received in process (1006). As discussed above, a pattern trigger may correspond to a type of outcome in the base game, a symbol or number appearing during the base game, or other gaming conditions occurring during the base game play. If a pattern trigger is not received, the method returns to process (1000) to wait for another wager to be received. If a pattern trigger is received, the pattern is modified (1008) and it is determined if the modified pattern corresponds to a bonus prize (1010). As discussed above, the pattern may be modified in process (1008) based on a specific portion of the game outcome, or may be modified at random when the pattern trigger is received.

If the modified pattern does not correspond to a bonus prize the method returns to process (1000) to wait for another wager to be received. If, on the other hand, the modified pattern does correspond to a bonus prize, the bonus prize is awarded to the player (1012) before the method returns to process (1000) to wait for another wager to be received. In some embodiments, the secondary pattern may be reset when a bonus prize is awarded to the player. In other embodiments, the player may have the option of redeeming the award or continuing to play in the hope of reaching a larger bonus award with the secondary pattern (see, for example, process 862 in FIG. 16). Other features or options similar to those discussed above for a pattern-based base game may also be applied to game play methods for gaming devices with secondary pattern game play.

FIG. 19 is a flow diagram showing another method of operating a gaming device having a bonus pattern display according to embodiments of the invention. This illustrated method is similar to the method discussed above with respect to FIG. 18, but deals with specific embodiments where the base game outcome directly impacts the secondary pattern.

Referring to FIG. 19, the gaming device operation method includes determining if a wager has been received in process (1020), and determining a base game outcome in process (1022) when a wager has been received. After the base game outcome has been determined, it is next determined if the base game outcome affects the pattern in the secondary pattern display (1024). If the base game outcome does not affect the pattern, the base game is displayed in process (1026) and the method returns to process (1020) to wait for another wager to be received.

If the base game outcome does impact the pattern on the secondary pattern display, the base game is displayed and the pattern is modified based on the determined base game outcome (1028). It is then determined in process (1030) whether the modified pattern corresponds to a bonus prize. If the modified pattern does not correspond to a bonus prize the method returns to process (1020) to wait for another wager to be received. If, on the other hand, the modified pattern does correspond to a bonus prize, the bonus prize is awarded to the player (1032) before the method returns to process (1020) to wait for another wager to be received.

Some embodiments of the invention have been described above, and in addition, some specific details are shown for purposes of illustrating the inventive principles. However, numerous other arrangements may be devised in accordance with the inventive principles of this patent disclosure. Further, well known processes have not been described in detail in order not to obscure the invention. Thus, while the invention is described in conjunction with the specific embodiments illustrated in the drawings, it is not limited to these embodiments or drawings. Rather, the invention is intended to cover alternatives, modifications, and equivalents that come within the scope and spirit of the inventive principles set out in the appended claims.

1. A method of operating a gaming device having a pattern game display, the pattern game display including a plurality of pattern elements having at least two states, the pattern elements arranged to facilitate completion of a visual image, the method comprising:
displaying an initial pattern of the pattern elements on the pattern game display, the initial pattern including at least one of the pattern elements in an unrevealed state;
receiving a player input from a player to initiate a gaming event on the gaming device;
determining a game outcome, the game outcome indicating one or more of the pattern elements in the pattern display;
generating a resultant pattern on the pattern display by modifying the one or more indicated pattern elements;
determining if the resultant pattern image satisfies one of a plurality of paytable conditions associated with awards;
displaying the resultant pattern image to the player; and
presenting the player with a determined prize when the modified pattern image satisfies at least one of the paytable conditions.

2. The method of claim 1, further comprising receiving a player input indicating a player-selected object to use as the visual image.

3. The method of claim 2, where receiving a player input indicating a player-selected object includes:
displaying a list of possible objects to a player to use as the visual image on the pattern display; and
receiving a selection of one of the possible objects from the list.

4. The method of claim 1, where the states of the pattern elements are determined at random in generating the initial pattern displayed on the pattern display.

5. The method of claim 1, where the states of the pattern elements are all set to unrevealed states in generating the initial pattern displayed on the pattern display.

6. The method of claim 1, where the states of the pattern elements are determined from a previous pattern state in generating the initial pattern displayed on the pattern display.

7. The method of claim 1, where the gaming device includes a base game display different than the pattern game display, and where determining a game outcome includes:
initiating a game displayed on the base game display;
determining a base game result for the game displayed on the base game display; and
determining pattern elements indicated by the base game result.

8. The method of claim 7, where the game displayed on the base game display includes a spinning reel game of chance.

9. The method of claim 7, where the game displayed on the base game display includes a video poker game of chance.

10. The method of claim 1, further comprising determining if any of the pattern elements indicated in determining the game outcome are associated with a bonus prize.

11. A gaming device comprising:
a player interface structured to receive inputs from a player;
a pattern display structured to display a pattern associated with game play to the player, the pattern including a plurality of pattern elements having at least two visual states, where the pattern is a visual image when each of the pattern elements are in a revealed state;
a memory configured to store instructions related to game play on the gaming device and a paytable; and
a processor configured to:
alter the visual states of the pattern elements in response to a game initiating input received via the player interface,
evaluate the altered pattern with reference to the stored paytable, and
cause a prize to be awarded to the player when the altered pattern meets a prize condition defined by the stored paytable.

12. The gaming device of claim 11, where the pattern display is structured to display the pattern elements in a grid format.

13. The gaming device of claim 12, where the visual image of the pattern is a representation of an object, a portion of the pattern elements include respective parts of the object representation when in the revealed state.

14. The gaming device of claim 11, where the pattern display is structured to display the pattern elements as objects related to a fixed visual object.

15. The gaming device of claim 11, where the player interface includes a pattern reset input device, the process being configured to reset a pattern when an input is received from the reset input device.

16. The gaming device of claim 11, where the player interface includes a data input mechanism configured to receive data related to a player-selected pattern to be used in creating the pattern shown on the pattern display.

17. The gaming device of claim 11, where the player interface includes a drawing pad structured to receive player inputs for the creation of a player-generated object to be used in creating the pattern shown on the pattern display.

18. The gaming device of claim 11, further comprising a goal pattern display configured to show the visual image of the pattern when each of the pattern elements are in the revealed states.

19. The gaming device of claim 11, where at least a portion of the pattern elements include a first visual state, a second visual state, and a third visual state, where the pattern element is associated with a first award when shown in the first visual state, associated with a second award greater than the first award when shown in the second visual state, and associated with a third award greater than the second award when shown in the third visual state.

20. A method of operating a gaming device to play a pattern based game of chance, the gaming device including a pattern display having a plurality of pattern elements with multiple visual states, the method comprising:
receiving a player input from a player to initiate a pattern game series;
generating an initial pattern by determining initial visual states for each pattern element;
receiving a wager from the player on a first pattern game in the pattern game series;
determining a first game outcome related to the visual states of the pattern elements;
displaying a first pattern outcome by using the determined first game outcome to change visual states of pattern elements indicated by the first game outcome;
receiving a wager from the player on a second pattern game in the pattern series;
determining a second game outcome related to the visual states of the pattern elements;
displaying a second pattern outcome by using the determined second game outcome to change visual states of pattern elements indicated by the second game outcome; and
presenting the player with a determined prize when the second pattern outcome satisfies at least one condition defined by a game paytable.

21. The method of claim 20, further comprising:
presenting the player with a prize offer when the determined first game outcome satisfies at least one condition defined by the game paytable after displaying the first game outcome; and
presenting the player with a determined prize associated with the prize offer when an input is received accepting the prize offer.

22. The method of claim 20, where determining a second game outcome related to the visual states of the pattern elements includes indicating only pattern elements with unrevealed visual states as eligible pattern elements to modify for the second game outcome.

23. A method of operating a gaming device, the method comprising:
displaying a first pattern on the gaming device, the first pattern including a plurality of pattern elements having multiple visual states;
receiving a player input from a player to initiate a gaming event on the gaming device;
determining a pattern-modifying game outcome in response to the received player input, the pattern-modifying game outcome indicating one or more pattern elements;
modifying the respective visual states of the indicated pattern elements in the first pattern to generate a second pattern; and
awarding a prize to the player when the second pattern satisfies a predetermined prize threshold.

24. The method of claim 23, wherein the initial pattern is selectable by the player.

25. The method of claim 23, wherein modifying the respective visual states of the indicated pattern elements includes modifying the respective visual states of the indicated pattern elements to complete a portion an image.

26. The method of claim 25, wherein the indicated pattern elements are selected by the player.

27. The method of claim 25, wherein the predetermined prize threshold includes a predefined number of completed portions of the image.

28. The method of claim 23, wherein modifying the respective visual states of the indicated pattern elements includes determining a blocker portion of an image to remove to reveal the respective pattern elements.

29. The method of claim 28, wherein the location of the blocker portion to remove is selected by the player.

30. The method of claim 28, wherein the predetermined prize threshold includes a predefined number of revealed portions of the image.

31. The method of claim 23, wherein modifying the respective visual states of the indicated pattern elements includes determining where on the pattern display to add a pattern element.

32. The method of claim 31, wherein modifying the respective visual states of the indicated pattern elements further includes determining a type of pattern element to add.
